(19) United States
(12) Patent Application Publication
(10) Pub. No.: US 2015/0347164 A1
(43) Pub. Date: Dec. 3, 2015

(54) Method and Device for Playing Plug-in in Browser

(71) Applicant: BEIJING QIHOO TECHNOLOGY COMPANY LIMITED, Beijing (CN)

(72) Inventors: Jinwei Li, BEIJING (CN); Yuesong He, Beijing (CN); Zhi Chen, Beijing (CN); Yu Fu, Beijing (CN); Ming Li, Beijing (CN); Huan Ren, Beijing (CN)

(21) Appl. No.: 14/655,138

(22) PCT Filed: Sep. 18, 2013
(86) PCT No.: PCT/CN2013/083729

§ 371 Date: Jun. 24, 2015

(30) Foreign Application Priority Data
Dec. 25, 2012 (CN) 201210572420.8
Dec. 25, 2012 (CN) 201210573012.4
Dec. 25, 2012 (CN) 201210573078.3

(51) Int. Cl. G06F 9/445; G06F 3/0484

(52) U.S. Cl. CPC G06F 9/44526; G06F 3/0484

(57) ABSTRACT

The invention discloses a method for playing a plug-in in a browser, and further discloses a corresponding device. The invention discloses a method, device and browser for creating a browser active object. This invention relates to network computing, and in particular, to a method for playing a video, a browser, a server and a system for playing a video. Therein, a method of the server comprises: receiving play information obtained by a browser, the play information being obtained from a video with a preset state appearing when being played; determining a video matching the play information, and obtaining address information of the matching video; and feeding the address information back to the browser.

### FIELD OF THE INVENTION

The invention relates to the field of network application, and in particular, to a method and device for playing a plug-in in a browser.

### BACKGROUND OF THE INVENTION

When a browser is opened, a page process of the browser will create an active object and then conduct various operations of the page. The active object usually refers to a plug-in of the browser, for example, an ActiveX plug-in.

Since the ActiveX plug-in needs to be embedded in a web page, the plug-in and the page will run in one and the same process. If the plug-in is stuck or crashes, this will cause the whole page to exit, which affects the stability of the page operation. When a page process is stuck or crashes, this will cause the ActiveX plug-in in the page to exit, which affects the stability of the ActiveX plug-in.

Moreover, since the position of the ActiveX plug-in in a web page is relatively stationary, a user can not dynamically adjust the size and display position of the ActiveX plug-in.

If the ActiveX plug-in is embedded in a web page, the load and play of the ActiveX plug-in will be triggered automatically when a user opens the web page. At present, many web pages are embedded with various video/audio plug-ins, for example, the Flash plug-in, of which the content may be some advertisements or content that a user does not care about. As soon as the user opens a web page, the Flash content will be automatically loaded and played in the first time. For a user, such unnecessary plug-in play results in the waste of user resources, for example, the waste of electricity, bandwidth and system resources, and further prolongs the page opening time.

A user queries various videos through a web page in a network, then clicks a corresponding video, and in turn directly plays it by a browser. However, when playing a video, since the bandwidth of a server itself which provides the video is relatively small, or there is a problem in the interaction between the video and the page, there will often occur a problem of the video being relatively stuck and slow when being played, that is, when being played, the video will often pause for a period of time to be able to continue being played, or even occur a problem that a video which has already been played for a period of time can not be cached and is unable to continue being played. Even further, there may occur a problem that after a web page is opened, a video can not be played at all as it is invalid.

### SUMMARY OF THE INVENTION

In view of the above problems, the invention is proposed to provide a device for playing a plug-in in a browser and a corresponding method for playing a plug-in in a browser, which overcome the above problems or at least partly solve or mitigate the above problems.

According to an aspect of the invention, there is provided a method for playing a plug-in in a browser comprising: creating an independent process different from a page process when loading and activating a first plug-in in the page process of the browser, and loading and activating a second plug-in in the independent process, wherein information of the first plug-in is copied by the second plug-in; calculating information of the second plug-in in the independent process, and obtaining the calculation result; and drawing and playing the second plug-in in a play window according to the calculation result.

According to another aspect of the invention, there is provided a device for playing a plug-in in a browser comprising: a creation module configured to create an independent process different from a page process when loading and activating a first plug-in in the page process of the browser, and load and activate a second plug-in in the independent process, wherein information of the first plug-in is copied by the second plug-in; a calculation module configured to calculate information of the second plug-in in the independent process, and obtain the calculation result; and a play module configured to draw and play the second plug-in in a play window according to the calculation result.

According to yet another aspect of the invention, there is provided a computer program comprising a computer readable code which causes a server to perform the method for playing a plug-in in a browser according to any of claims 1-10, when said computer readable code is running on the server.

According to still another aspect of the invention, there is provided a computer readable medium storing the computer program as claimed in claim 21 therein.

In an embodiment of the invention, a first plug-in is loaded and activated in a page process of the browser, but the first plug-in will not be drawn and played, instead, an independent process which is different from the page process is created, and a second plug-in is loaded and activated in the independent process, and the second plug-in is utilized to realize copy of information of the first plug-in. Since the information of the first plug-in is consistent with that of the second plug-in, the calculation result obtained by calculating the information of the second plug-in is consistent with that obtained by calculating the information of the first plug-in, and then the played content by drawing and playing the second plug-in in a play window according to the calculation result should also be consistent. However, since the second plug-in is arranged in the independent process and shares the same process with the independent process, and it and the page process are respectively applied to two different processes. Therefore, the operation of the second plug-in is independent from the operation of the page process, and a problem occurs to one party can not affect the stability of the other party. If the second plug-in is stuck or crashes, it will not result in the exit of the whole web page, which can improve the stability of the operation of the page. Similarly, when the page process is stuck or crashes, it will also not result in the exit of the second plug-in in the page, which improves the stability of the operation of the plug-in. Thus, it can be seen that the method for playing a plug-in in a browser provided by an embodiment of the invention can improve the stability of the operation of the browser without affecting the play effect.

Further, since the first plug-in is not really executed, and the second plug-in is the real executive main body, the first plug-in may be called a proxy object and the second plug-in an active object. In an embodiment of the invention, by running a proxy object in the page process, and running an active object in the independent process, a real browser plug-in, e.g., a real ActiveX plug-in, is made to be separated from the page process, such that a browser process embedded in the browser plug-in will not be affected when a problem occurs to the browser plug-in, that is, the page process will not be affected when a problem occurs to the browser plug-in, thereby improving the stability of the browser. Meanwhile, when a security problem such as a virus, etc. occurs to the browser plug-in, the operation of the page process will not be affected since the browser plug-in is separated from the page process, thereby also improving the security of the browser.

In addition, when a problem occurs to the browser plug-in, an operation such as suspending, reducing the privilege or terminating, etc. may be performed on an object thread that runs the browser plug-in, such that the independent process may conduct a directional distribution of a system resource such as the occupancy of the memory and the occupancy of CPU by the browser plug-in, etc., thus realizing a better way of distributing and recycling resources, and more reasonably scheduling computer resources, and terminating a process to cause the process to exit may also make resource recycling more thorough.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a processing flow chart of a method for playing a plug-in in a browser according to an embodiment in a first part of the invention;

FIG. 2 shows a schematic diagram of communication between the page process and the independent process according to an embodiment in the first part of the invention;

FIG. 3 shows a schematic diagram of playing a flash plug-in in the page process when the flash plug-in has no play window according to an embodiment in the first part of the invention;

FIG. 4 shows a schematic diagram of playing a flash plug-in in the page process when the flash plug-in has a play window according to an embodiment in the first part of the invention; and

FIG. 5 shows a structural diagram of a device for playing a plug-in in a browser according to an embodiment in the first part of the invention.

FIG. 6 shows a flow chart of a method for creating a browser active object according to a first embodiment in a second part of the invention;

FIG. 7 shows a flow chart of a method for creating a browser active object according to a second embodiment in the second part of the invention;

FIG. 8 shows a flow chart of a method for creating a browser active object according to a third embodiment in the second part of the invention;

FIG. 9 shows a flow chart of a method for creating a browser active object according to a fourth embodiment in the second part of the invention;

FIG. 10 shows a structural block diagram of a device for creating a browser active object according to a fifth embodiment in the second part of the invention;

FIG. 11 shows a structural block diagram of a device for creating a browser active object according to a sixth embodiment in the second part of the invention;

FIG. 12 shows a structural block diagram of a device for creating a browser active object according to a seventh embodiment in the second part of the invention;

FIG. 13 shows a structural block diagram of a device for creating a browser active object according to an eighth embodiment in the second part of the invention.

FIG. 14 shows a flow chart of a method for playing a video according to an embodiment one in a third part of the invention;

FIG. 15 shows a flow chart of a first method for presetting a video library according to the embodiment one in the third part of the invention;

FIG. 16 shows a flow chart of a second method for presetting a video library according to the embodiment one in the third part of the invention;

FIG. 17 shows a flow chart of a method for playing a video according to an embodiment two in the third part of the invention;

FIG. 18 shows a flow chart of a method for playing a video according to an embodiment three in the third part of the invention;

FIG. 19 shows a structural diagram of a server according to an embodiment four in the third part of the invention;

FIG. 20 shows a structural diagram of a server according to the embodiment four in the third part of the invention;

FIG. 21 shows a structural diagram of a system for playing a video according to an embodiment five in the third part of the invention.

FIG. 22 shows schematically a block diagram of a server for carrying out a method according to the invention; and

FIG. 23 shows schematically a storage unit for retaining or carrying a program code implementing a method according to the invention.

### DETAILED DESCRIPTION OF THE INVENTION

In the following, the invention will be further described in connection with the drawings and the particular embodiments.

### First Part

To solve at least one of the above technical problems, an embodiment of the invention provides a method for playing a plug-in in a browser for realizing independent operations of a plug-in and a page process and ensuring that when a problem occurs to any one of them, the stability of the other will not be affected. FIG. 1 shows a processing flow chart of a method for playing a plug-in in a browser according to an embodiment of the invention. With reference to FIG. 1, the method for playing a plug-in in a browser comprises step S102 to step S106. The particular description of each step is as follows.

Step S102, an independent process different from a page process is created when loading and activating a first plug-in in the page process of the browser, and a second plug-in is loaded and activated in the independent process, wherein the second plug-in copies information of the first plug-in.

Step S104, information of the second plug-in is calculated in the independent process, and the calculation result is obtained.

Step S106, the second plug-in is drawn and played in a play window according to the calculation result.

In the embodiment of the invention, a first plug-in is loaded and activated in a page process of the browser, but the first plug-in will not be drawn and played, instead, an independent process which is different from the page process is created, and a second plug-in is loaded and activated in the independent process, and the second plug-in is utilized to realize copy of information of the first plug-in. Since the information of the first plug-in is consistent with that of the second plug-in, the calculation result obtained by calculating the information of the second plug-in is consistent with that obtained by calculating the information of the first plug-in, and then the played content by drawing and playing the second plug-in in a play window according to the calculation result should also be consistent. However, since the second plug-in is arranged in the independent process and shares the same process with the independent process, and it and the page process are respectively applied to two different processes. Therefore, the operation of the second plug-in is independent from the operation of the page process, and that a problem occurs to one party can not affect the stability of the other party. If the second plug-in is stuck or crashes, it will not result in the exit of the whole web page, which can improve the stability of the operations of the page. Similarly, when the page process is stuck or crashes, it will also not result in the exit of the second plug-in in the page, which improves the stability of the operation of the plug-in. Thus, it can be seen that the method for playing a plug-in in a browser provided by the embodiment of the invention can improve the stability of the operation of the browser without affecting the play effect.

Further, since the first plug-in is not really executed, and the second plug-in is the real executive main body, the first plug-in may be called a proxy object and the second plug-in an active object. In the embodiment of the invention, by running a proxy object in the page process, and running an active object in the independent process, a real browser plug-in, e.g., a real ActiveX plug-in, is made to be separated from the page process, such that a browser process embedded in the browser plug-in will not be affected when a problem occurs to the browser plug-in, that is, the page process will not be affected when a problem occurs to the browser plug-in, thereby improving the stability of the browser. Meanwhile, when a security problem such as a virus, etc. occurs to the browser plug-in, the operation of the page process will not be affected since the browser plug-in is separated from the page process, thereby also improving the security of the browser.

In addition, when a problem occurs to the browser plug-in, an operation such as suspending, reducing the privilege or terminating, etc. may be performed on an object thread that runs the browser plug-in, such that the independent process may conduct a directional distribution of a system resource such as the occupancy of the memory and the occupancy of CPU by the browser plug-in, etc., thus realizing a better way of distributing and recycling resources and more reasonably scheduling computer resources, and that terminating a process to cause the process to exit may also make resource recycling more thorough.

It needs to be noted that in the embodiment of the invention, the first plug-in is called a proxy object, and the second plug-in is called an active object, which reflects that the initiatives of the first plug-in and the second plug-in are different. In practice, the method for playing a plug-in in a browser provided by the embodiment of the invention can realize bidirectional communications; the page process and the independent process are not fixed, and there may occur a situation in a subsequent execution procedure, in which the plug-in in the independent process is separated into the page process for execution, at this point, the roles of the proxy object and the active object are exchanged, and the particular processing procedure thereof is similar.

In step S102, it is mentioned that the second plug-in needs to copy information of the first plug-in in order to ensure a consistent play effect. In particular, a preferred copy mode is provided in this example. First, a first control object is generated for the first plug-in in the page process. Second, a second control object is generated for the second plug-in in the independent process. Then, the second control object and the first control object are utilized to communicate with each other to obtain the information of the first plug-in, and then the second control object is utilized to send the obtained information of the first plug-in to the second plug-in.

Since an operation needs to be done between a plug-in and a control object corresponding thereto, there need have an interface for information interaction between the two. In an embodiment of the invention, it is arranged such that the plug-in and the control object operate on each other using a pointer between them, wherein the pointer can invoke a plurality of standard interfaces. In particular, the first plug-in and the first control object operate on each other using a pointer between them, the second plug-in and the second control object operate on each other using a pointer of the same type between them. Preferably, the pointer may be an IUnknown pointer, and the IUnknown pointer will invoke many standard interfaces, for example, IOleObject, IViewObject, etc.

When an interactive communication is done utilizing the second control object and the first control object, for the convenience of communication, a first window associated with the first control object can be created in the page process, and then a second window associated with the second control object is created in the independent process. Afterwards, an interactive communication is done utilizing the established first window and second window.

In the procedure of implementation, the information of the interactive communication may be any information related to playing a plug-in, for example, the size of the plug-in, the focus of a thread in the page process, the refresh operation of a thread of the page process, the execution of a script, etc. Here, the particular information is just taken as illustrations, and does not pose a definition to the information itself, and the communication may further involve other information of plug-in play.

It is mentioned in step S106 that the second plug-in is drawn and played in a play window according to the calculation result. That is, when playing the second plug-in, there may be divided two cases, one is that there is not a play window of the first plug-in in the page process, and the other is that there is a play window of the first plug-in in the page process. Now, the two cases will be described particularly.

In the first case, when there is not a play window of the first plug-in in the page process, the independent process is utilized to newly create a play window. At this point, since the play window is newly created by the independent process, it is not linked with the original page process. One or more timer is arranged in the independent process to regularly obtain the calculation result of the second plug-in, and in turn it suffices to draw and play the second plug-in in the newly created play window according to the calculation result.

In the second case, when there is an original play window of the first plug-in in the page process, at this point, like the first case, the independent process is equally utilized to newly create a play window. However, since the original play window exists, a link needs to be established between the newly created play window and the original play window. In particular, the newly created play window is set to be the parent window of the original play window, and then the second plug-in is drawn and played in the newly created play window according to the calculation result.

The newly created play window can move or zoom on the browser, thereby realizing the mobility, scalability, etc. of the play window. If it is desired to present the play window at the play window of the original page process, then it is only needed to arrange the newly created play window at the position of the window of the original page process.

Further, in the procedure of implementation, if the page process initiates a request for obtaining a play window, the independent process notifies the page process that there is no play window. The page process can not learn about the existence of a play window, and then can not control the play window, thereby realizing the separation of a plug-in from the page process, and improving the stability of the browser.

In any one of the above preferred embodiments, the first plug-in and/or the second plug-in is an ActiveX plug-in.

The flash plug-in is a commonly used ActiveX plug-in, and now, taking the flash plug-in running in the page process as an example, the method for playing a plug-in in a browser provided by an embodiment of the invention will be described particularly.

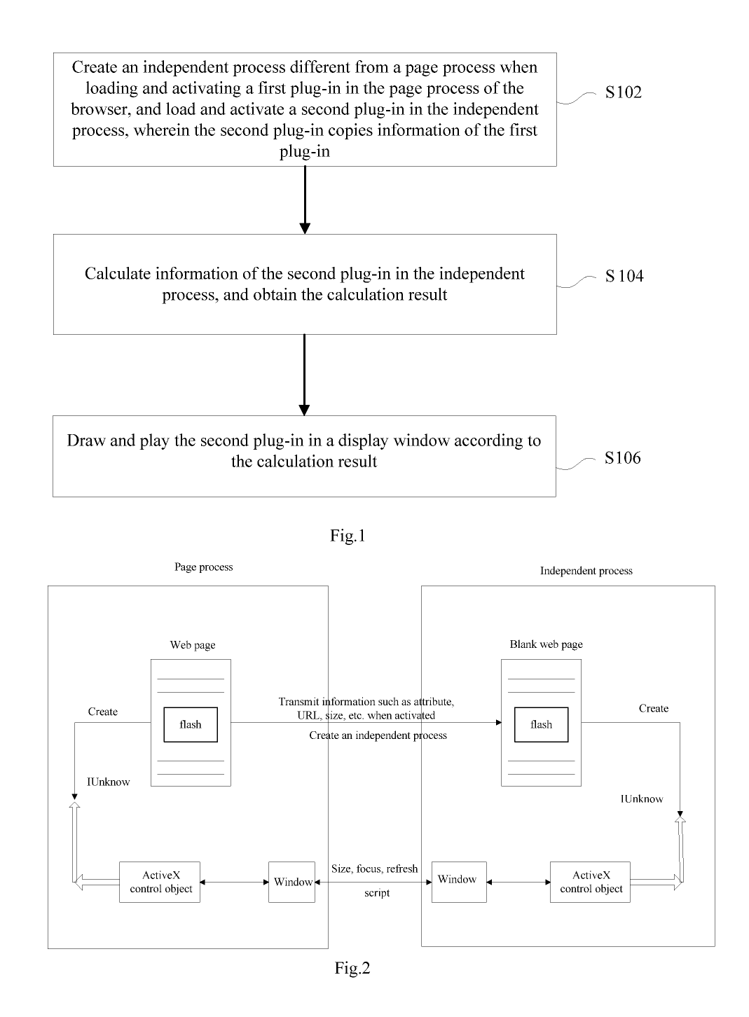

FIG. 2 shows a schematic diagram of communication between the page process and the independent process according to an embodiment of the invention.

At the page process side,

In a case where there is a flash in the web page, when the browser creates an ActiveX plug-in (i.e., the first plug-in mentioned above), it will query a registry to examine whether the corresponding plug-in has been installed in the system according to the CLSID or ProgID (CLSID is obtained by CLSIDFromProgID) of the plug-in, and if installed, the creation procedure will continue.

The browser obtains the IUnknown pointer of the corresponding plug-in by invoking CoGetClassObject, and then performs an interoperation through a standard interface. The execution procedure of CoGetClassObject is as follows. The registry is queried for an ActiveX path through the CLSID, and after the ActiveX path is obtained, LoadLibrary is invoked to load the ActiveX plug-in, its derivative function DllGetClassObject is invoked to obtain a class factory pointer (IClassFactory), and then the CreateInstance method of IClassFactory is invoked to obtain the IUnknown pointer corresponding to the ActiveX plug-in.

Here, it needs to be noted that when the ActiveX plug-in is loaded, CoGetClassObject is Hooked (intercepted) to create an ActiveX control object (i.e., the first control object corresponding to the first plug-in). The ActiveX control object comprises a series of interfaces, for example, many standard interfaces that the IUnknown pointer will invoke, such as IOleObject, IViewObject, etc. Then, when CreateInstance of IClassFactory is invoked, the created ActiveX control object is returned to the IUnknown pointer of the ActiveX plug-in.

At the independent process side,

When the page process activates the ActiveX plug-in, relevant information such as attribute, URL and size, etc. of the control is extracted, then an independent process is created, and the ActiveX plug-in (i.e., the second plug-in) is loaded in the independent process.

In particular, a document is created, an object is inserted therein, the independent process invokes CoGetClassObject, Hooks the CoGetClassObject and then creates another ActiveX control object (i.e., the second control object corresponding to the second plug-in), and the ActiveX control object comprises a series of interfaces, for example, many standard interfaces that the IUnknown pointer will invoke, such as IOleObject, IViewObject, etc. Then, when CreateInstance of IClassFactory is invoked, the created another ActiveX control object is returned to the IUnknown pointer of the ActiveX plug-in of the independent process.

Between the page process and the independent process,

In the created two ActiveX control objects, a window associated with each control object is respectively created for communication. In particular, the two control objects may interact with each other with respect to size, focus, refresh, script and other information.

According to the method provided by this embodiment, all the requests of direct interactions between the page process and the independent process can be intercepted. If the page process and the independent process need to communicate, the information interaction between the two processes is realized by the pre-created two ActiveX control objects. Due to the independence of the independent process and the page process, the particular calculation procedure of the flash plug-in is performed in the independent process, and therefore will not affect the original page process.

Further, in the procedure of displaying a flash, a play window can be newly created, and the calculated result in the independent process is drawn in the newly created play window. Now, it is divided into the following two cases and described particularly as follows.

The first case, in which the flash plug-in in the page process is a flash plug-in without a play window.

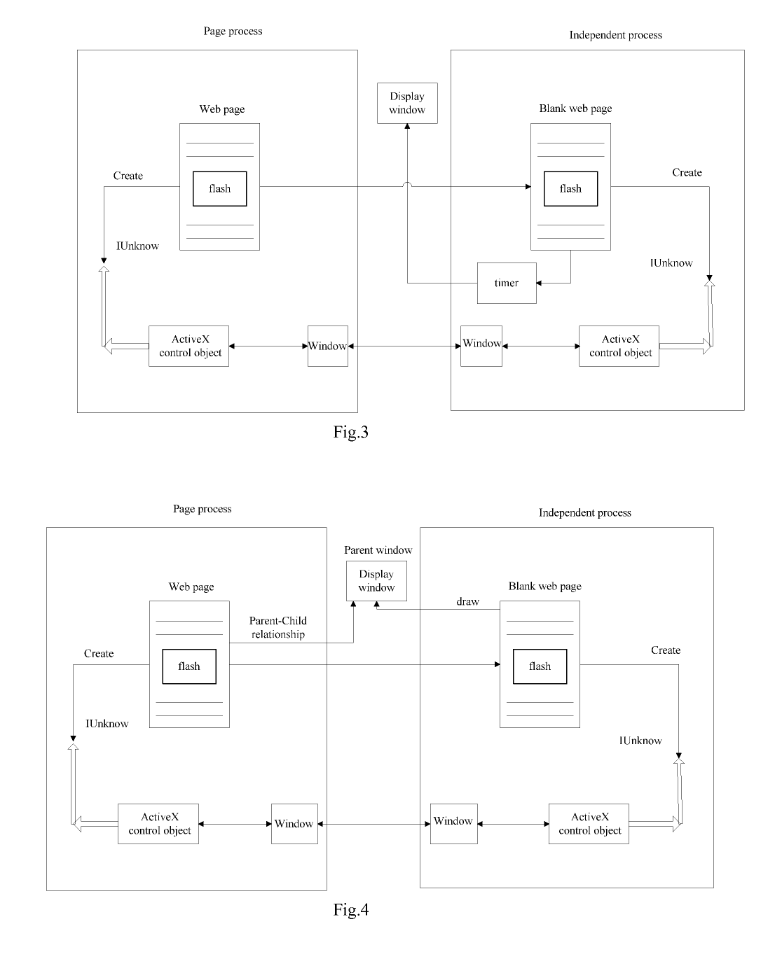

FIG. 3 shows a schematic diagram of playing a flash plug-in in the page process when the flash plug-in has no play window according to an embodiment of the invention. In FIG. 3, when the result calculated in the independent process is drawn in a newly created play window, there is a timer in the independent process, the Draw method of the IViewObject interface is invoked at a predetermined time interval to obtain drawing data to draw the calculated data into the newly created flash play window.

When a user wants to display in the flash window of the original page, the newly created play window can be arranged at the position of the flash play window of the original page, but the window can move and zoom, etc. to meet the demands of the user.

The second case, in which the flash plug-in in the page process is a flash plug-in with a play window

FIG. 4 shows a schematic diagram of playing a flash plug-in in the page process when the flash plug-in has a play window according to an embodiment of the invention. The result calculated in the independent process is drawn in a newly created play window, and the newly created play window is set to be the parent window of the flash play window in the original page.

In particular, by invoking the GetWindow method of the IOleWindow interface of the flash object, its corresponding window is obtained, and then the parent window of the flash play window is set through SetParent.

When a user wants to display in the flash window of the original page, the newly created play window can be arranged at the position of the flash play window of the original page, but the window can move and zoom, etc. to meet the demands of the user.

Further, in the original page process, at the timing of obtaining a window, the independent process returns null. In particular, when the page process scrolls the page, it will invoke the GetWindow method of the IOleWindow interface of the flash object to judge whether the flash object has a window, and if yes, moves the window by sending WM_MOVE message, and prohibits the page process from moving the flash window by returning NULL by GetWindow.

It can be seen from the above that the embodiment provides a method for playing a plug-in in a browser, realizes real stripping of a plug-in from a web page, and in turn solves the problems of the functions of an embedded plug-in being insufficient and a plug-in and a page affecting each other.

Based on one and the same inventive concept, an embodiment of the invention further provides a device for playing a plug-in in a browser, which can realize the method for playing a plug-in in a browser in any one of the above preferred embodiments. FIG. 5 shows a structural diagram of a device for playing a plug-in in a browser according to an embodiment of the invention. With reference to FIG. 5, the device for playing a plug-in in a browser comprises at least:

a creation module 501 configured to create an independent process different from a page process when loading and activating a first plug-in in the page process of the browser, and load and activate a second plug-in in the independent process, wherein the second plug-in copies information of the first plug-in;

a calculation module 502 configured to calculate information of the second plug-in in the independent process, and obtain the calculation result; and

a play module 503 configured to draw and play the second plug-in in a play window according to the calculation result.

In a preferred embodiment, the creation module 501 may be further configured to:

generate a first control object for the first plug-in in the page process;

generate a second control object for the second plug-in in the independent process;

utilize the second control object and the first control object to communicate with each other to obtain the information of the first plug-in; and

utilize the second control object to send the obtained information of the first plug-in to the second plug-in.

In a preferred embodiment, the first plug-in and the first control object operate on each other using a pointer between them, wherein the pointer can invoke a plurality of standard interfaces; and

the second plug-in and the second control object operate on each other using a pointer of the same type between them.

In a preferred embodiment, the creation module 501 may be further configured to:

create a first window associated with the first control object in the page process;

create a second window associated with the second control object in the independent process; and

utilize the first window and the second window to conduct an interactive communication.

In a preferred embodiment, the information of the interactive communication comprises at least one of the following:

the size of the plug-in, the focus of a thread in the page process, the refresh operation of a thread of the page process, and the execution of a script.

In a preferred embodiment, the play module 503 may be further configured to:

utilize the independent process to newly create a play window when there is not a play window of the first plug-in in the page process;

regularly obtain the calculation result according to a timer of the independent process; and

draw and play the second plug-in in the newly created play window according to the calculation result.

In a preferred embodiment, the play module 503 may be further configured to:

utilize the independent process to newly create a play window when there is an original play window of the first plug-in in the page process, and set the newly created play window to be the parent window of the original play window; and

draw and play the second plug-in in the newly created play window according to the calculation result.

The newly created play window can move or zoom on the browser.

In a preferred embodiment, with reference to FIG. 5, the device for playing a plug-in in a browser may further comprise a notification module 504. When receiving a request for obtaining a play window initiated by the page process, the notification module 504 can utilize the independent process to notify the page process that there is no play window.

In a preferred embodiment, the first plug-in and/or the second plug-in is an ActiveX plug-in.

By employing the method and device for playing a plug-in in a browser provided by embodiments of the invention, the following beneficial effects can be achieved.

In the embodiment of the invention, a first plug-in is loaded and activated in a page process of the browser, but the first plug-in will not be drawn and played, instead, an independent process which is different from the page process is created, and a second plug-in is loaded and activated in the independent process, and the second plug-in is utilized to realize copy of information of the first plug-in. Since the information of the first plug-in is consistent with that of the second plug-in, the calculation result obtained by calculating the information of the second plug-in is consistent with that obtained by calculating the information of the first plug-in, and then the played content by drawing and playing the second plug-in in a play window according to the calculation result should also be consistent. However, since the second plug-in is arranged in the independent process and shares the same process with the independent process, and it and the page process are respectively applied to two different processes. Therefore, the operation of the second plug-in is independent of the operation of the page process, and that a problem occurs to one party can not affect the stability of the other party. If the second plug-in is stuck or crashes, it will not result in the exit of the whole web page, which can improve the stability of the operations of the page. Similarly, when the page process is stuck or crashes, it will also not result in the exit of the second plug-in in the page, which improves the stability of the operation of the plug-in. Thus, it can be seen that the method for playing a plug-in in a browser provided by the embodiment of the invention can improve the stability of the operation of the browser without affecting the play effect.

Further, since the first plug-in is not really executed, and the second plug-in is the real executive main body, the first plug-in may be called a proxy object and the second plug-in an active object. In the embodiment of the invention, by running a proxy object in the page process, and running an active object in the independent process, a real browser plug-in, e.g., a real ActiveX plug-in, is made to be separated from the page process, such that a browser process embedded in the browser plug-in will not be affected when a problem occurs to the browser plug-in, that is, the page process will not be affected when a problem occurs to the browser plug-in, thereby improving the stability of the browser. Meanwhile, when a security problem such as a virus, etc. occurs to the browser plug-in, the operation of the page process will not be affected since the browser plug-in is separated from the page process, thereby also improving the security of the browser.

In addition, when a problem occurs to the browser plug-in, an operation such as suspending, reducing the privilege or terminating, etc. may be performed on an object thread that runs the browser plug-in, such that the independent process may conduct a directional distribution of a system resource such as the occupancy of the memory and the occupancy of CPU by the browser plug-in, etc., thus realizing a better way of distributing and recycling resources and more reasonably scheduling computer resources, and that terminating a process to cause the process to exit may also make resource recycling more thorough.

### Second Part

In the following several embodiments, creating a Flash plug-in is taken as an example for illustration, but the invention is not limited to the Flash plug-in, it may also be other ActiveX plug-in, such as plug-ins like Baidu video, QVOD (QvodPlayer), etc.

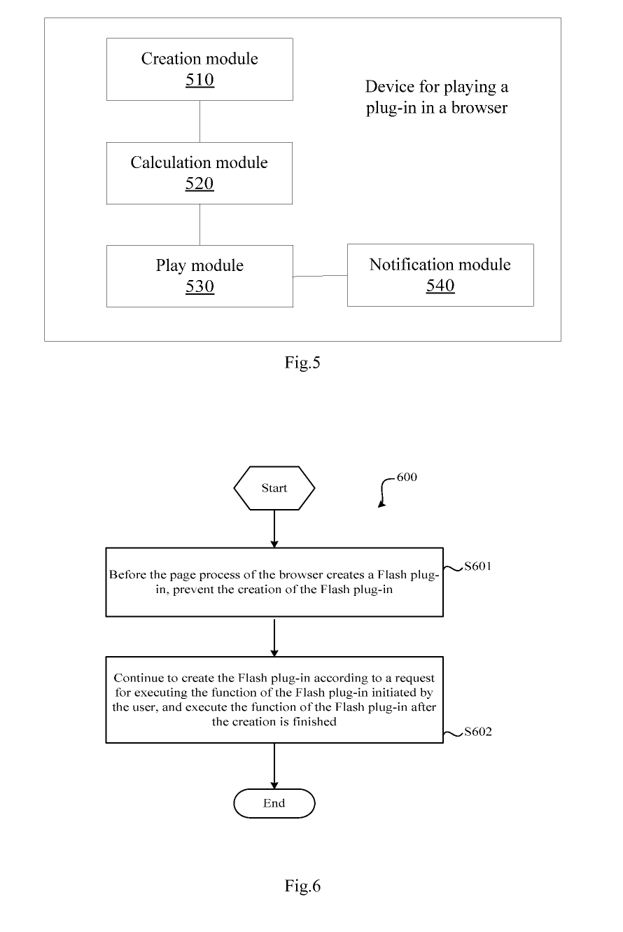

FIG. 6 shows a flow chart of a method 600 for creating a browser active object according to a first embodiment of the invention. As shown in FIG. 6, the method 600 begins with step S601, in which before the page process of the browser creates a Flash plug-in, the creation of the Flash plug-in is prevented. In particular, in a case where there is a Flash plug-in in the page, the page process of the browser obtains the class identification (CLSID) or the component string identifier (ProgID) of the Flash plug-in by the method of CLSIDFromProgID, and according to the existing flow, the page process subsequently queries the registry according to the CLSID or ProgID of the Flash plug-in to examine whether the plug-in has been installed in the system, and if it is examined that the plug-in has been installed, then further creates the Flash plug-in. However, the difference between the present method and the existing flow lies in that after the CLSID or ProgID is obtained, it is judged whether it is the CLSID or ProgID of a Flash plug-in, and if yes, the execution of the action of querying the registry is stopped, and thus the Flash plug-in will not be created. It needs to be noted that stopping the execution of the action of querying the registry is an optional implementation of preventing a Flash plug-in from being created, and in this method, it may also be possible to prevent further creating a Flash plug-in after querying the registry to confirm that the Flash plug-in has been installed. By this step, although there is a Flash plug-in in the page, the corresponding Flash content will not be played in the page after the page is opened since the creation of the Flash plug-in is prevented.

Subsequently, the method 600 proceeds to step S602, in which the Flash plug-in continues to be created according to a request for executing the function of the Flash plug-in initiated by the user, and the function of the Flash plug-in is executed after the creation is finished, namely, the corresponding Flash content is played. After the page is opened, if the user wants to watch the Flash content, he can click to play the Flash, and the page process will not prevent the Flash plug-in from being created any more after receiving a request for clicking to play the Flash from the user, and continues to create the Flash plug-in. Taking stopping the action of querying the registry in the foregoing as an example, the page process continues to execute the operation of querying the registry according to the CLSID or ProgID of the Flash plug-in to examine whether the plug-in has been installed in the system, and if it is examined that the plug-in has been installed, then further creates the Flash plug-in. After the creation of the Flash plug-in is finished, the corresponding Flash content will be played according to a default attribute, thereby realizing the play of the Flash content corresponding to the Flash plug-in on demand.

According to the method for creating a browser active object provided by the embodiment, before the page process of the browser creates a Flash plug-in, the creation of the Flash plug-in is prevented by default; after a user initiates a request for playing a Flash, the Flash plug-in continues to be created, and after the creation of the Flash plug-in is finished, the corresponding Flash content is played, thereby realizing the play of the Flash content corresponding to the Flash plug-in on demand. Comparing to the existing art, a waste of user resources due to unnecessary plug-in play is avoided, and electricity, bandwidth and system resources are saved. Meanwhile, when the user requires to play the Flash content again, the page does not need to be refreshed, thus realizing the play of the Flash content on demand. Moreover, in the method provided by the embodiment, when a page is loaded, the creation of a Flash plug-in is prevented by default, and the limited resources are used for loading the page, which promotes the loading speed of the page.

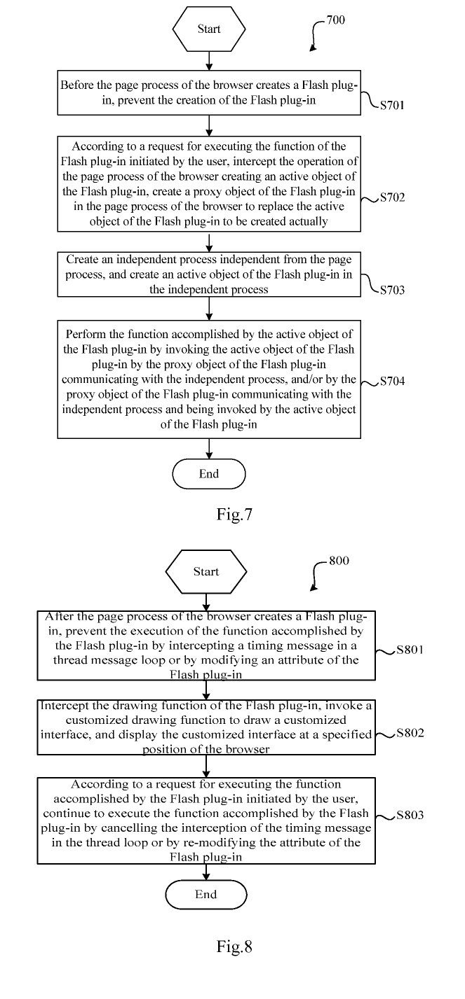

FIG. 7 shows a flow chart of a method 700 for creating a browser active object according to a second embodiment the invention. Unlike the first embodiment, after the user initiates a request for executing the function accomplished by an active object, a real Flash plug-in is caused to be separated from the page process by creating a proxy object in the page process and continuing to create the active object in an independent process. As shown in FIG. 7, the method 700 begins with step S701, in which before the page process of the browser creates a Flash plug-in, the creation of the Flash plug-in is prevented. In a case where there is a Flash plug-in in the page, the page process of the browser obtains the CLSID or ProgID of the Flash plug-in by the CLSIDFromProgID method, and after the CLSID or ProgID is obtained, it is judged whether it is the CLSID or ProgID of a Flash plug-in, and if yes, the execution of the action of querying the registry is stopped, and thus the Flash plug-in will not be created. Stopping the execution of the action of querying the registry is an optional implementation of preventing a Flash plug-in from being created, and in this method, it may also be possible to prevent further creating a Flash plug-in after querying the registry to confirm that the Flash plug-in has been installed. By this step, although there is a Flash plug-in in the page, the corresponding Flash content will not be played in the page after the page is opened since the creation of the Flash plug-in is prevented.

Subsequently, the method 700 proceeds to step S702, in which according to a request for executing the function of the Flash plug-in initiated by the user, the operation of the page process of the browser creating an active object of the Flash plug-in is intercepted, a proxy object of the Flash plug-in is created in the page process of the browser to replace the active object of the Flash plug-in to be created actually, and the proxy object of the Flash plug-in is run in the page process. In particular, after the page is opened, if the user wants to watch the Flash content, he may click to play the Flash, and the page process will not prevent the Flash plug-in from being created any more after receiving a request for clicking to play the Flash from the user, and continues to create the Flash plug-in. Taking stopping the execution of the action of querying the registry in the foregoing as an example, the page process continues to execute the operation of querying the registry according to the CLSID or ProgID of the Flash plug-in to examine whether the plug-in has been installed in the system, and if it is examined that the plug-in has been installed, then further creates the Flash plug-in. Here, when the page process is ready to further create the Flash plug-in, it intercepts CoGetClassObject, and creates a proxy object of the Flash plug-in, and the proxy object of the Flash plug-in comprises a series of interfaces, including many standard interfaces that the IUnknown pointer (also called an interface pointer herein) will invoke, for example, IOleObject, IViewObject, etc. Then, when CreateInstance of IClassFactory is invoked, the created proxy object of the Flash plug-in is returned to the IUnknown pointer of the page process.

Subsequently, the method 700 proceeds to step S703, in which an independent process independent from the page process is created, and an active object of the Flash plug-in is created in the independent process. Here, the active object of the Flash plug-in is actually the real Flash plug-in. In particular, when the page process activates the proxy object of the Flash plug-in, relevant information such as attribute, URL and size, etc. of the Flash plug-in is extracted, and then an independent process is created. In particular, a document is created, an object is inserted therein, the independent process invokes CoGetClassObject, intercepts the CoGetClassObject and creates an active object of the Flash plug-in. The active object of the Flash plug-in comprises a series of interfaces, including many standard interfaces that the IUnknown pointer will invoke, for example, IOleObject, IViewObject, etc. Then, when CreateInstance of IClassFactory is invoked, the created active object of the Flash plug-in is returned to the IUnknown pointer of the independent process. Next, in the proxy object of the Flash plug-in and the active object of the Flash plug-in, windows associated with the plug-in objects are created respectively which allows the proxy object of the Flash plug-in and the active object of the Flash plug-in to communicate. Through the two windows, the two objects may interact with each other with respect to size, focus, refresh, script and other information of the Flash.

Subsequently, the method 700 proceeds to step S704, in which the proxy object of the Flash plug-in communicates with the independent process to invoke the active object of the Flash plug-in, and/or the proxy object of the Flash plug-in communicates with the independent process to be invoked by the active object of the Flash plug-in, to perform the function accomplished by the active object of the Flash plug-in. After the creation of the active object of the Flash plug-in is finished, according to a request for clicking to play the Flash from the user, the proxy object of the Flash plug-in communicates with the independent process to invoke the active object of the Flash plug-in, such that the active object of the Flash plug-in plays the corresponding Flash content, thereby realizing the play of the Flash content corresponding to the Flash plug-in on demand.

According to the method for creating a browser active object provided by the embodiment, before the page process of the browser creates a Flash plug-in, the creation of the Flash plug-in is prevented by default; after a user initiates a request for playing a Flash, a real Flash plug-in is created in an independent process, and after the creation of the real Flash plug-in is finished, the corresponding Flash content is played by invoking the real Flash plug-in, thereby realizing the play of the Flash content corresponding to the Flash plug-in on demand. As compared to the existing art, a waste of user resources due to unnecessary plug-in play is avoided, and electricity, bandwidth and system resources are saved. Meanwhile, when the user requires to play the Flash content again, the page does not need to be refreshed, thus realizing the play of the Flash content on demand. Moreover, in the method provided by the embodiment, when a page is loaded, the creation of a Flash plug-in is prevented by default, and the limited resources are used for loading the page, which promotes the loading speed of the page. Further, in this method, by running a proxy object in the page process, and running an active object in the independent process, a real Flash plug-in is made to be separated from the page process, such that the page process will not be affected when a problem occurs to the Flash plug-in, thereby improving the stability of the browser, and especially when a security problem such as a virus, etc. occurs to the Flash plug-in, the page process will also not be affected, thereby improving the security of the browser; and meanwhile, the normal operation of the Flash plug-in will not be affected when a problem occurs to the page process, thereby improving the stability of the plug-in.

FIG. 8 shows a flow chart of a method 800 for creating a browser active object according to a third embodiment of the invention. As shown in FIG. 8, the method 800 begins with step S801, in which after the page process of the browser creates a Flash plug-in, the function accomplished by executing the Flash plug-in is prevented, namely, the Flash plug-in is prevented from playing the corresponding Flash content, by intercepting a timing message in a thread message loop or by modifying an attribute of the Flash plug-in. In a case where there is a Flash plug-in in the page, the page process of the browser obtains the CLSID or ProgID of the Flash plug-in through the CLSIDFromProgID method, and subsequently, the page process queries the registry according to the CLSID or ProgID of the Flash plug-in to examine whether the plug-in has been installed in the system, and if it is examined that the plug-in has been installed, then further creates the Flash plug-in. The page process obtains the IUnknown pointer of the Flash plug-in by invoking CoGetClassObject, and invokes a standard interface to perform a relevant operation according to the IUnknown pointer, thereby completing the creation of the Flash plug-in. Therein, the execution procedure of CoGetClassObject is as follows. The registry is queried for an ActiveX path through the CLSID, and after the ActiveX path is obtained, LoadLibrary is invoked to load the Flash plug-in, the derivative function DllGetClassObject is invoked to obtain a class factory pointer (IClassFactory), and then the CreateInstance method of IClassFactory is invoked to obtain the IUnknown pointer corresponding to the Flash plug-in. In the case of obtaining the IUnknown pointer, a default attribute of the Flash plug-in can be obtained by invoking a relevant interface, and it is modified. In general, the default attribute of the Flash plug-in is play, and at this point, the goal of preventing the Flash plug-in from playing the Flash content is achieved by modifying the default attribute of the Flash plug-in from play to pause or stop. In particular, a function recording attributes of the Flash plug-in can be found according to the IUnknown pointer of the Flash plug-in, and the attribute of the Flash plug-in can be modified by invoking the function. Modifying the attribute of the Flash plug-in is an optional implementation of preventing the Flash plug-in from playing the Flash content, and such implementation is applicable to a Flash plug-in playing an animation. The method further provides another implementation of preventing the Flash plug-in from playing the Flash content, that is, intercepting a timing message in a thread message loop, and the scope of application of such an implementation is wider, which applies to the Flash plug-in playing an animation and the Flash plug-in playing a video. In particular, the timing message (e.g., the 0x401 message) in the thread message loop is a driving message of the Flash plug-in, and the Flash plug-in will only execute its corresponding function if it receives the timing message regularly. In the method, by intercepting the timing message, such that the Flash plug-in can not receive the message, thus the Flash plug-in will not play the corresponding Flash content.

Optionally, after step S801, the method 800 proceeds to step S802, in which the drawing function of the Flash plug-in is intercepted, a customized drawing function is invoked to draw a customized interface, and the customized interface is displayed at a specified position of the browser. After the Flash content is prevented from being played in step S801, an interface which stops play will occur at a specified position of the browser where the Flash content should be displayed originally. The method can replace the interface which stops play with a customized interface, for example, a blank screen, a customized picture or a customized Flash, etc. A particularly adopted approach is to intercept the drawing function of the Flash plug-in, which drawing function is used for drawing the interface which stops play, and invoke a customized drawing function to draw a customized interface and display it.

Subsequently, the method 800 proceeds to step S803, in which according to a request for executing the function accomplished by the Flash plug-in initiated by the user, the function accomplished by the Flash plug-in continues to be executed, namely, the Flash content continues to be played, by cancelling the interception of the timing message in the thread loop or by re-modifying the attribute of the Flash plug-in. If in step S801, the Flash plug-in is prevented from playing the Flash content by modifying the attribute of the Flash plug-in, then this step re-modifies the attribute of the Flash plug-in, that is, the attribute of the Flash plug-in is modified from pause or stop to play, and thus the Flash plug-in can continue to play the corresponding Flash content. If in step S801, the Flash plug-in is prevented from playing the Flash content by intercepting the timing message, then this step cancels the interception of the timing message, such that the Flash plug-in continues to play the corresponding Flash content.

According to the method for creating a browser active object provided by the embodiment, after the page process of the browser creates a Flash plug-in, the Flash plug-in is prevented from playing the Flash content by intercepting a timing message in a thread message loop or by modifying an attribute of the Flash plug-in; after the user initiates a request for playing the Flash, the Flash plug-in is caused to continue to play the Flash content by cancelling the interception of the timing message in the thread message loop or by re-modifying the attribute of the Flash plug-in, thereby realizing the play of the Flash content corresponding to the Flash plug-in on demand. As compared to the existing art, a waste of user resources due to unnecessary plug-in play is avoided, and electricity, bandwidth and system resources are saved. Meanwhile, when the user requires to play the Flash content again, the page does not need to be refreshed, thus realizing the play of the Flash content on demand. Moreover, in this method, when a Flash plug-in is prevented from playing the Flash content, the Flash plug-in has already been created, and after the user initiates a request for playing the Flash again, it is not needed to create a Flash plug-in again, the play can be started directly, and the response time is relatively short.

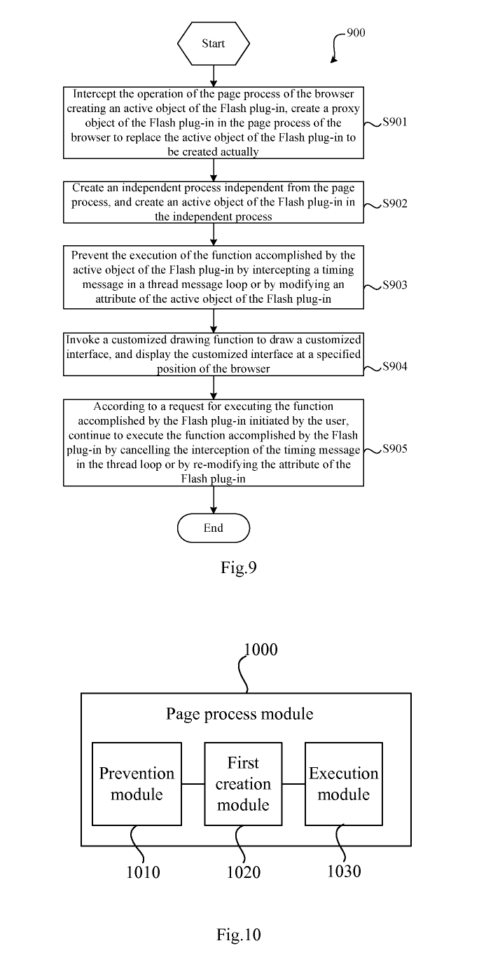

FIG. 9 shows a flow chart of a method 900 for creating a browser active object according to a fourth embodiment of the invention. Unlike the above three embodiments, in this embodiment, a real Flash plug-in is caused to be separated from the page process by creating a proxy object in the page process and continuing to create a active object in an independent process. As shown in FIG. 9, the method 900 begins with step S901, in which the operation of the page process of the browser creating an active object of the Flash plug-in is intercepted, a proxy object of the Flash plug-in is created in the page process of the browser to replace the active object of the Flash plug-in to be created actually, and the proxy object of the Flash plug-in is run in the page process. In particular, in a case where there is a Flash plug-in in the page, when the page process is ready to create the Flash plug-in, it intercepts CoGetClassObject, and creates a proxy object of the Flash plug-in, and the proxy object of the Flash plug-in comprises a series of interfaces, including many standard interfaces that the IUnknown pointer will invoke, for example, IOleObject, IViewObject, etc. Then, when CreateInstance of IClassFactory is invoked, the created proxy object of the Flash plug-in is returned to the IUnknown pointer of the page process.

Subsequently, the method 900 proceeds to step S902, in which an independent process independent from the page process is created, and an active object of the Flash plug-in is created in the independent process. Here, the active object of the Flash plug-in is actually the real Flash plug-in. In particular, when the page process activates the proxy object of the Flash plug-in, relevant information such as attribute, URL and size, etc. of the Flash plug-in is extracted, and then an independent process is created. In particular, a document is created, an object is inserted therein, the independent process invokes CoGetClassObject, intercepts the CoGetClassObject and creates an active object of the Flash plug-in. The active object of the Flash plug-in comprises a series of interfaces, including many standard interfaces that the IUnknown pointer will invoke, for example, IOleObject, IViewObject, etc. Then, when CreateInstance of IClassFactory is invoked, the created active object of the Flash plug-in is returned to the IUnknown pointer of the independent process. Next, in the proxy object of the Flash plug-in and the active object of the Flash plug-in, windows associated with the plug-in objects are created respectively which allows the proxy object of the Flash plug-in and the active object of the Flash plug-in to communicate. By the two windows, the two objects can interact with each other with respect to size, focus, refresh, script and other information of the Flash.

Subsequently, the method 900 proceeds to step S903, in which the function accomplished by executing the active object of the Flash plug-in is prevented, namely, the Flash plug-in is prevented from playing the corresponding Flash content, by intercepting a timing message in a thread message loop or by modifying an attribute of the active object of the Flash plug-in. The relevant content of this step is similar to that of the third embodiment, and the difference lies in that this step is executed in the independent process, whereas the corresponding step of the third embodiment is executed in the page process.

Optionally, after step S903, the method 900 proceeds to step S904, in which a customized drawing function is invoked to draw a customized interface, and the customized interface is displayed at a specified position of the browser. After the Flash content is prevented from being played in step S903, an interface which stops play will occur at a specified position of the browser where the Flash content should be displayed originally. The method can replace the interface which stops play with a customized interface, for example, a blank screen, a customized picture or a customized Flash, etc. In particular, the follow two approaches may be employed:

1) intercept the drawing function of the active object of the Flash plug-in in the independent process, invoke a customized drawing function to draw a customized interface, invoke the active object of the Flash plug-in by the proxy object of the Flash plug-in communicating with the independent process, and display the customized interface at a specified position of the browser. In particular, the drawing function of the active object of the Flash plug-in is intercepted in the independent process, the drawing function is used for drawing an interface which stops play, a customized drawing function is invoked to draw a customized interface, the active object of the Flash plug-in is invoked by the proxy object of the Flash plug-in communicating with the independent process, the customized interface is sent to the proxy object of the Flash plug-in via a created window, and the customized interface is displayed at a specified position.

2) intercept in the page process the action of invoking the active object of the Flash plug-in by the proxy object of the Flash plug-in communicating with the independent process, invoke a customized drawing function to draw a customized interface, and display the customized interface at a specified position of the browser. In particular, an interface which stops play is drawn in the independent process by invoking the drawing function of the active object of the Flash plug-in, the active object of the Flash plug-in is invoked by the proxy object of the Flash plug-in communicating with the independent process, the interface which stops play can be sent to the proxy object of the Flash plug-in via a created window, and at this point, this action is intercepted in the page process, a customized drawing function is invoked to draw a customized interface, and the customized interface is displayed at a specified position.

Subsequently, the method 900 proceeds to step S905, in which according to a request for executing the function accomplished by the Flash plug-in initiated by the user, the function accomplished by the Flash plug-in continues to be executed, namely, the Flash content continues to be played, by cancelling the interception of the timing message in the thread loop or by re-modifying the attribute of the Flash plug-in. Therein, the continuous execution of the function accomplished by the Flash plug-in is realized in a way that the active object of the Flash plug-in is invoked by the proxy object of the Flash plug-in communicating with the independent process, and/or the proxy object of the Flash plug-in communicates with the independent process to be invoked by the active object of the Flash plug-in. And yet, cancelling the interception of the timing message in the thread loop or re-modifying the attribute of the Flash plug-in is performed in the independent process.

According to the method for creating a browser active object provided by the embodiment, a proxy object of the Flash plug-in is created in the page process of the browser, a real Flash plug-in is created in an independent process, and after the creation of the real Flash plug-in is finished, the Flash plug-in is prevented from playing the Flash content by intercepting a timing message in a thread message loop or by modifying an attribute of the Flash plug-in; after the user initiates a request for playing the Flash, the Flash plug-in is caused to continue to play the Flash content by cancelling the interception of the timing message in the thread message loop or by re-modifying the attribute of the Flash plug-in, thereby realizing the play of the Flash content corresponding to the Flash plug-in on demand. As compared to the existing art, a waste of user resources due to unnecessary plug-in play is avoided, and electricity, bandwidth and system resources are saved. Meanwhile, when the user requires to play the Flash content again, the page does not need to be refreshed, thus realizing the play of the Flash content on demand. Moreover, in this method, when a Flash plug-in is prevented from playing the Flash content, the Flash plug-in has already been created, and after the user initiates a request for playing the Flash again, it is not needed to create a Flash plug-in again, the play can be started directly, and the response time is relatively short. Further, in this method, by running a proxy object in the page process, and running an active object in the independent process, a real Flash plug-in is made to be separated from the page process, such that the page process will not be affected when a problem occurs to the Flash plug-in, thereby improving the stability of the browser, and especially when a security problem such as a virus, etc. occurs to the Flash plug-in, the page process will also not be affected, thereby improving the security of the browser; and meanwhile, the normal operation of the Flash plug-in will not be affected when a problem occurs to the page process, thereby improving the stability of the plug-in.

FIG. 10 shows a structural block diagram of a device for creating a browser active object according to a fifth embodiment of the invention. As shown in FIG. 10, the device comprises a prevention module 1010, a first creation module 1020 and an execution module 1030. Further, the prevention module 1010, the first creation module 1020 and the execution module 1030 are all sub-modules of a page process module 1000.

Therein, the prevention module 1010 is configured to prevent the creation of an active object in a page process before the browser creates the active object. The first creation module 1020 continues to create an active object in the page process according to a request for executing the function accomplished by an active object initiated by a user. The execution module 1030 is configured to execute the function accomplished by an active object after the active object is created.

Taking a Flash plug-in as an example, before the page creates a Flash plug-in, the page process obtains the CLSID or ProgID of the Flash plug-in through the CLSIDFromProgID method, and judges whether it is the CLSID or ProgID of a Flash plug-in, and if yes, the prevention module 1010 prevents the action of the first creation module 1020, such that it stops the execution of querying the registry, thereby preventing the Flash plug-in from being created. After the page process receives a request for clicking to play the Flash from a user, the prevention module 1010 relieves the prevention, and the first creation module 1020 continues the execution of the action of querying the registry according to the CLSID or ProgID of the Flash plug-in, to examine whether the plug-in has been installed in the system, and if it is examined that the plug-in has been installed, then further creates the Flash plug-in. After the creation of the Flash plug-in is finished, the execution module 1030 will play the corresponding Flash content according to a default attribute, thereby realizing the play of the Flash content corresponding to the Flash plug-in on demand.

According to the device for creating a browser active object provided by the embodiment, before a page process of the browser creates a Flash plug-in, the prevention module prevents the creation of the Flash plug-in by default; after a user initiates a request for playing a Flash, the first creation module continues to create the Flash plug-in, and after the creation of the Flash plug-in is finished, the execution module plays the corresponding Flash content, thereby realizing the play of the Flash content corresponding to the Flash plug-in on demand. As compared to the existing art, a waste of user resources due to unnecessary plug-in play is avoided, and electricity, bandwidth and system resources are saved. Meanwhile, when the user requires to play the Flash content again, the page does not need to be refreshed, thus realizing the play of the Flash content on demand. Moreover, in the device provided by the embodiment, when a page is loaded, the creation of a Flash plug-in is prevented by default, and the limited resources are used for loading the page, which promotes the loading speed of the page.

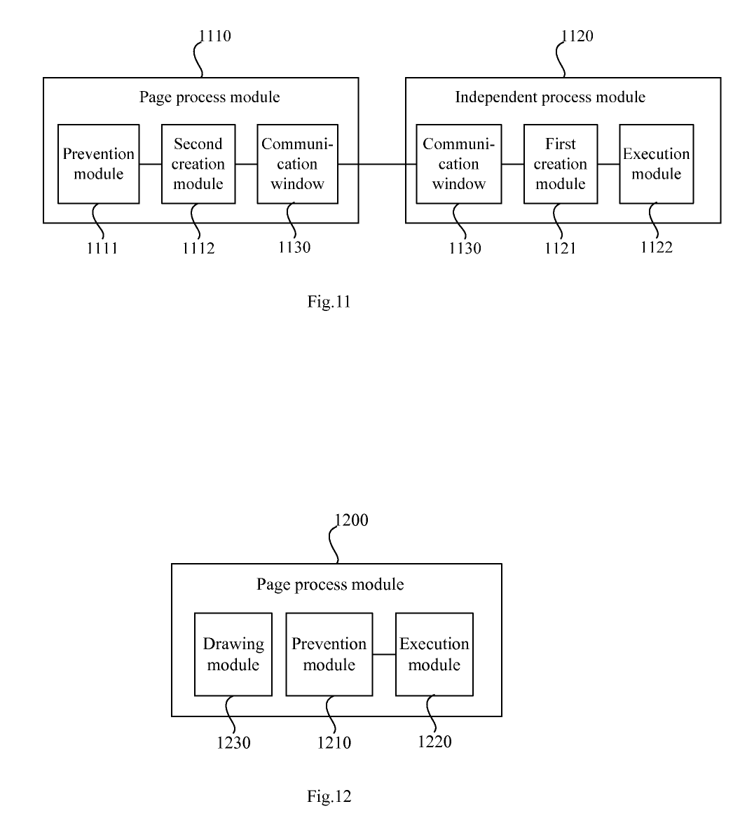

FIG. 11 shows a structural block diagram of a device for creating a browser active object according to a sixth embodiment of the invention. As shown in FIG. 11, the device comprises a page process module 1110 and an independent process module 1120, and communication windows 1130 created in the page process module 1110 and the independent process module 1120 respectively. Therein, the page process module 1110 comprises sub-modules: a prevention module 1111 and a second creation module 1112; and the independent process module 1120 comprises sub-modules: a first creation module 1121 and an execution module 1122.

The prevention module 1111 is configured to prevent the creation of an active object in the page process before the browser creates the active object. The second creation module 1112 is configured to, according to a request for executing the function accomplished by an active object initiated by the user, intercept the operation of the page process of the browser loading an active object, and create a proxy object in the page process of the browser to replace the active object to be created actually, wherein the proxy object is run in the page process.

The first creation module 1121 is configured to create an active object in an independent process independent from the page process of the browser. The execution module 1122 invokes the active object by the proxy object communicating with the independent process via the communication window 1130, and/or executes the function accomplished by the active object by the proxy object communicating with the independent process via the communication window 1130 and being invoked by the active object.

Taking a Flash plug-in as an example, before the page creates a Flash plug-in, the page process obtains the CLSID or ProgID of the Flash plug-in through the CLSIDFromProgID method, and judges whether it is the CLSID or ProgID of a Flash plug-in, and if yes, the prevention module 1111 prevents the action of the second creation module 1112, such that it stops the execution of querying the registry, thereby preventing the Flash plug-in from being created. After the page process receives a request for clicking to play the Flash from a user, the prevention module 1111 relieves the prevention, and the second creation module 1112 continues the execution of the action of querying the registry according to the CLSID or ProgID of the Flash plug-in, to examine whether the plug-in has been installed in the system, and if it is examined that the plug-in has been installed, then further creates the Flash plug-in. Here, when the page process is ready to further create the Flash plug-in, the second creation module 1112 intercepts CoGetClassObject, and creates a proxy object of the Flash plug-in, and the proxy object of the Flash plug-in comprises a series of interfaces, including many standard interfaces that the IUnknown pointer will invoke, for example, IOleObject, IViewObject, etc. Then, when CreateInstance of IClassFactory is invoked, the created proxy object of the Flash plug-in is returned to the IUnknown pointer of the page process. When the page process activates the proxy object of the Flash plug-in, relevant information such as attribute, URL and size, etc. of the Flash plug-in is extracted, and then an independent process is created by the independent process module 1120. When the independent process invokes CoGetClassObject, the first creation module 1121 intercepts the CoGetClassObject and creates an active object of the Flash plug-in. The active object of the Flash plug-in comprises a series of interfaces, including many standard interfaces that the IUnknown pointer will invoke, for example, IOleObject, IViewObject, etc. Then, when CreateInstance of IClassFactory is invoked, the created active object of the Flash plug-in is returned to the IUnknown pointer of the independent process. After the creation of the active object of the Flash plug-in is finished, according to a request for clicking to play the Flash from the user, the execution module 1122 invokes the active object of the Flash plug-in by the proxy object of the Flash plug-in communicating with the independent process, such that the active object of the Flash plug-in plays the corresponding Flash content, thereby realizing the play of the Flash content corresponding to the Flash plug-in on demand.

According to the device for creating a browser active object provided by the embodiment, before the page process of the browser creates a Flash plug-in, the prevention module prevents the creation of the Flash plug-in by default; after a user initiates a request for playing a Flash, the first creation module creates a real Flash plug-in in an independent process, and after the creation of the real Flash plug-in is finished, the execution module plays the corresponding Flash content by invoking the real Flash plug-in, thereby realizing the play of the Flash content corresponding to the Flash plug-in on demand. As compared to the existing art, a waste of user resources due to unnecessary plug-in play is avoided, and electricity, bandwidth and system resources are saved. Meanwhile, when the user requires to play the Flash content again, the page does not need to be refreshed, thus realizing the play of the Flash content on demand. Moreover, in the device provided by the embodiment, when a page is loaded, the creation of a Flash plug-in is prevented by default, and the limited resources are used for loading the page, which promotes the loading speed of the page. Further, in this device, by running a proxy object in the page process, and running an active object in the independent process, a real Flash plug-in is made to be separated from the page process, such that the page process will not be affected when a problem occurs to the Flash plug-in, thereby improving the stability of the browser, and especially when a security problem such as a virus, etc. occurs to the Flash plug-in, the page process will also not be affected, thereby improving the security of the browser; and meanwhile, the normal operation of the Flash plug-in will not be affected when a problem occurs to the page process, thereby improving the stability of the plug-in.

FIG. 12 shows a structural block diagram of a device for creating a browser active object according to a seventh embodiment of the invention. As shown in FIG. 12, the device comprises a prevention module 1210 and an execution module 1220. Further, the prevention module 1210 and the execution module 1220 are sub-modules of a page process module 1200.

Therein the prevention module 1210 is configured to, after the browser creates an active object, prevent the execution of the function accomplished by the active object by intercepting a timing message in a thread message loop or by modifying an attribute of the active object. The execution module 1220 is configured to, according to a request for executing the function accomplished by the active object initiated by a user, continue to execute the function accomplished by the active object by cancelling the interception of the timing message in the thread message loop or by re-modifying the attribute of the active object.

Taking a Flash plug-in as an example, in a case where there is a Flash plug-in in the page, the page process of the browser obtains the CLSID or ProgID of the Flash plug-in through the CLSIDFromProgID method, and subsequently, the page process queries the registry according to the CLSID or ProgID of the Flash plug-in to examine whether the plug-in has been installed in the system, and if it is examined that the plug-in has been installed, then further creates the Flash plug-in. The page process obtains the IUnknown pointer of the Flash plug-in by invoking CoGetClassObject, and invokes a standard interface to perform a relevant operation according to the IUnknown pointer, thereby completing the creation of the Flash plug-in. In the case of obtaining the IUnknown pointer, the prevention module 1210 can find a function recording attributes of the Flash plug-in according to the IUnknown pointer, and can modify an attribute of the Flash plug-in by invoking the function, for example, modify the default attribute of the Flash plug-in from play to pause or stop, so as to achieve the goal of preventing the Flash plug-in from playing the Flash content. The prevention module 1210 can also intercept the timing message in the thread message loop, e.g., the 0x401 message, and prevent the Flash plug-in from playing the Flash content. After the user initiates a request for executing the function accomplished by the Flash plug-in, the execution module 1220 can re-modify the attribute of the Flash plug-in, for example, modify the attribute of the Flash plug-in from pause or stop to play, and thus the Flash plug-in can continue to play the corresponding Flash content. The execution module 1220 can also cancel the interception of the timing message, such that the Flash plug-in continues to play the corresponding Flash content.

Optionally, the device may further comprise a drawing module 1230, and the drawing module 1230 is also a sub-module of the page process module 1200. The drawing module 1230 is configured to intercept the drawing function of the active object, invoke a customized drawing function to draw a customized interface, and display the customized interface at a specified position of the browser. By the drawing module 1230, the interface which stops play can be replaced with a customized interface, for example, a blank screen, a customized picture or a customized Flash, etc.

According to the device for creating a browser active object provided by the embodiment, after the page process of the browser creates a Flash plug-in, the prevention module prevents the Flash plug-in from playing the Flash content by intercepting a timing message in a thread message loop or by modifying an attribute of the Flash plug-in; after the user initiates a request for playing the Flash, the execution module causes the Flash plug-in to continue to play the Flash content by cancelling interception of the timing message in the thread message loop or by re-modifying the attribute of the Flash plug-in, thereby realizing the play of the Flash content corresponding to the Flash plug-in on demand. As compared to the existing art, a waste of user resources due to unnecessary plug-in play is avoided, and electricity, bandwidth and system resources are saved. Meanwhile, when the user requires to play the Flash content again, the page does not need to be refreshed, thus realizing the play of the Flash content on demand. Moreover, in this device, when a Flash plug-in is prevented from playing the Flash content, the Flash plug-in has already been created, and after the user initiates a request for playing the Flash again, it is not needed to create a Flash plug-in again, the play can be started directly, and the response time is relatively short.

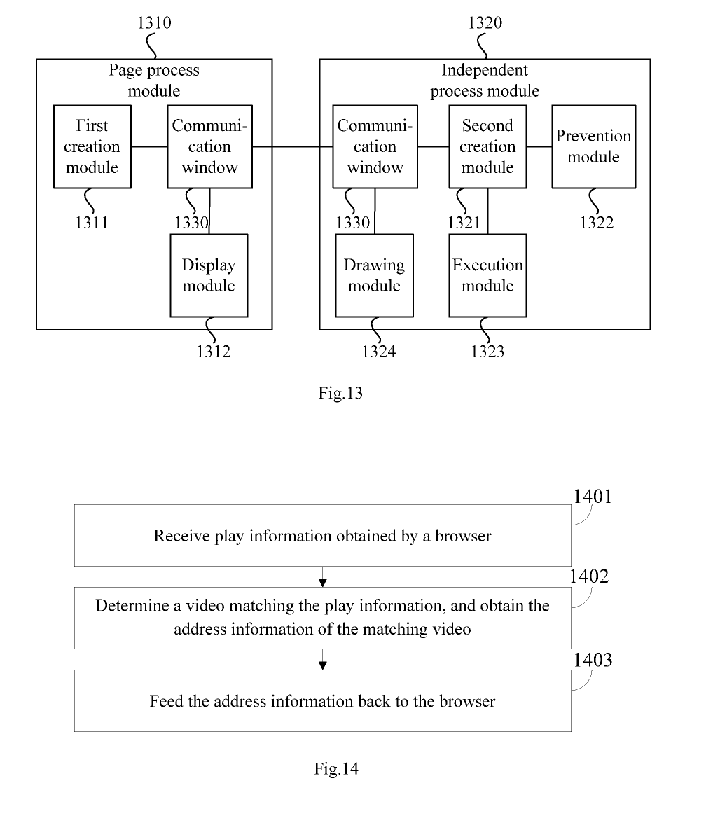

FIG. 13 shows a structural block diagram of a device for creating a browser active object according to an eighth embodiment of the invention. As shown in FIG. 13, the device comprises a page process module 1310 and an independent process module 1320, and communication windows 1330 created in the page process module 1310 and the independent process module 1320 respectively. Therein, the page process module 1310 comprises sub-modules: a first creation module 1311; and the independent process module 1320 comprises sub-modules: a second creation module 1321, a prevention module 1322 and an execution module 1323.

The first creation module 1311 is configured to intercept the operation of the page process of the browser loading an active object, create a proxy object in the page process of the browser to replace the active object to be created actually, wherein the proxy object is run in the page process.

The second creation module 1321 is configured to create an active object in an independent process independent from the page process. The prevention module 1322 is configured to, after the browser creates an active object, prevent the execution of the function accomplished by the active object by intercepting a timing message in a thread message loop or by modifying an attribute of the active object. The execution module 1323 is configured to, according to a request for executing the function accomplished by the active object initiated by a user, continue to execute the function accomplished by the active object by cancelling the interception of the timing message in the thread message loop or by re-modifying the attribute of the active object. The execution module 1323 is further configured to invoke the active object by the proxy object communicating with the independent process via the communication window 1330, and/or continue to execute the function accomplished by the active object by the proxy object communicating with the independent process via the communication window 1330 and being invoked by the active object.

Taking a Flash plug-in as an example, in a case where there is a Flash plug-in in the page, when the first creation module 1311 is ready to create the Flash plug-in, it intercepts CoGetClassObject, and creates a proxy object of the Flash plug-in, and the proxy object of the Flash plug-in comprises a series of interfaces, including many standard interfaces that the IUnknown pointer will invoke, for example, IOleObject, IViewObject, etc. Then, when CreateInstance of IClassFactory is invoked, the created proxy object of the Flash plug-in is returned to the IUnknown pointer of the page process. When the page process activates the proxy object of the Flash plug-in, relevant information such as attribute, URL and size, etc. of the Flash plug-in is extracted, and then an independent process is created by the independent process module 1320. When the independent process invokes CoGetClassObject, the second creation module 1321 intercepts the CoGetClassObject and creates an active object of the Flash plug-in. The active object of the Flash plug-in comprises a series of interfaces, including many standard interfaces that the IUnknown pointer will invoke, for example, IOleObject, IViewObject, etc. Then, when CreateInstance of IClassFactory is invoked, the created active object of the Flash plug-in is returned to the IUnknown pointer of the independent process. The prevention module 1322 prevents the execution of the function accomplished by the active object of the Flash plug-in, namely, prevents the Flash plug-in from playing the corresponding Flash content, by intercepting a timing message (e.g., the 0x401 message) in a thread message loop or by modifying an attribute of the active object of the Flash plug-in. Further, the prevention module 1322 finds a function recording attributes of the Flash plug-in according to the IUnknown pointer, and can modify an attribute of the Flash plug-in by invoking the function. After the user initiates a request for executing the function accomplished by the Flash plug-in, the execution module 1323 continues to execute the function accomplished by the Flash plug-in, namely, continues to play the Flash content, by cancelling the interception of the timing message in the thread loop or by re-modifying the attribute of the Flash plug-in.

Optionally, the independent process module 1320 can further comprise a drawing module 1324 configured to intercept the drawing function of the active object in the independent process, and invoke a customized drawing function to draw a customized interface. The page process module 1310 comprises a display module 1312 configured to invoke the active object by the proxy object communicating with the independent process, and display the customized interface at a specified position of the browser. As another alternative implementation, the page process module comprises a drawing module configured to intercept in the page process the action of invoking the active object by the proxy object communicating with the independent process, invoke a customized drawing function to draw a customized interface, and display the customized interface at a specified position of the browser.

According to the device for creating a browser active object provided by the embodiment, a proxy object of the Flash plug-in is created in the page process of the browser, a real Flash plug-in is created in an independent process, and after the creation of the real Flash plug-in is finished, the prevention module prevents the Flash plug-in from playing the Flash content by intercepting a timing message in a thread message loop or by modifying an attribute of the Flash plug-in; after the user initiates a request for playing the Flash, the execution module causes the Flash plug-in to continue to play the Flash content by cancelling the interception of the timing message in the thread loop or by re-modifying the attribute of the Flash plug-in, thereby realizing the play of the Flash content corresponding to the Flash plug-in on demand. As compared to the existing art, a waste of user resources due to unnecessary plug-in play is avoided, and electricity, bandwidth and system resources are saved. Meanwhile, when the user requires to play the Flash content again, the page does not need to be refreshed, thus realizing the play of the Flash content on demand. Moreover, in this device, when a Flash plug-in is prevented from playing the Flash content, the Flash plug-in has already been created, and after the user initiates a request for playing the Flash again, it is not needed to create a Flash plug-in again, the play can be started directly, and the response time is relatively short. Further, in this device, by running a proxy object in the page process, and running an active object in the independent process, a real Flash plug-in is made to be separated from the page process, such that the page process will not be affected when a problem occurs to the Flash plug-in, thereby improving the stability of the browser, and especially when a security problem such as a virus, etc. occurs to the Flash plug-in, the page process will also not be affected, thereby improving the security of the browser; and meanwhile, the normal operation of the Flash plug-in will not be affected when a problem occurs to the page process, thereby improving the stability of the plug-in.

The invention further provides a browser comprising any one of the devices for creating a browser active object as described in the fifth to eighth embodiments.

### Third Part

A user may query various videos through a web page in a network, then click a corresponding video, and in turn directly play it by a browser. However, when playing a video, since the bandwidth of a server itself which provides the video is relatively small, or there is a problem in the interaction between the video and the page, there will often occur a problem of the video being relatively stuck and slow when being played, that is, when being played, the video will often pause for a period of time to be able to continue being played, or even occur a problem that a video which has already been played for a period of time can not be cached and is unable to continue being played. Even further, there may occur a problem that after a web page is opened, a video can not be played at all as it is invalid.

With respect to the above problems, an embodiment of the invention provides a method for playing a video, which can obtain corresponding play information when a preset state appears in video play, then determine the address information of a video matching the play information, and feed the address information back, such that the browser can play the video according to the address information, and the video can be watched normally, and the problems of being stuck, slow and failing to be played, etc. are avoided as much as possible.

### Embodiment One

This embodiment will be discussed mainly with respect to the processing of a server in the method for playing a video, which particularly comprises:

FIG. 14 shows a flow chart of a method for playing a video according to an embodiment one of the invention.

In step 1401, receiving play information obtained by a browser.

Therein, the play information is obtained in a video in which a preset state appears when played.

The browser will constantly detect the play state of the video in the procedure of playing the video, and when it is detected that the preset state occurs to the video during play, will obtain the play information of the video, for example, the name of the video, the total time of playing the video, etc. Then, the play information will be sent to a server, such that the server can receive the play information.

In step 1402, determining a video matching the play information, and obtaining the address information of the matching video.

Then, the server can perform detection and matching according to the play information, thereby determine a video matching the play information, and obtain the address information of the matching video. Therein, the address information can comprise the play address of the matching video.

For example, the play information comprises the name of the video and the play address of the video, and the server can conduct matching according to the name, thereby obtain the video matching the name and the play address of each video, and form the play address into the address information. Further, the play address of each video can be compared with the play address in the play information, a play address identical to the play address in the play information is rejected, and the address information is formed.

In step 1403, feeding the address information back to the browser.

Then, the address information can be fed back to the browser, such that the browser can play a video according to the address information.

In summary, in the embodiment of the invention, corresponding play information can be obtained when a preset state appears in video play, then the address information of a video matching the play information is determined, and the address information is fed back, such that the browser can play a video according to the address information, thus a user can watch the video normally, and the problems of being stuck, slow and failing to be played, etc. are avoided as much as possible.

In the embodiment of the invention, there is further comprised:

presetting a video library in the server.

information of various video resources in a network can be collected in advance, can the collected information is formed into video information, and thereby a video library is set in the server, and then the video library is configured to store video information of videos in the network.

One form of the video information is as shown in table 1:

TABLE 1

| Video description information | | | Play | Play | |
|---|---|---|---|---|---|
| Name | Introduction | . . . | address | parameter | Rank |
| XX | AAA | . . . | 1.com | 256 kb/s | 1 |
| | | | 2.com | 232 kb/s | 2 |
| | | | . . . | . . . | . . . |
| . . . | . . . | . . . | . . . | . . . | . . . |
| | | | . . . | . . . | . . . |
| | | | . . . | . . . | . . . |

The video information comprises video description information and a play address.

Therein, the video description information can be relevant information describing a video, comprising the name, introduction, play time, etc., and therefore, a corresponding video can be determined by the video description information.

Since videos are divided into different categories, for example, TV play, movie, variety show, profile video, etc., the video description information may also comprise the category of a video. In addition, a video of a different category further comprises respective video description information, for example, the video description information of a TV play or a movie may comprise main actors, introduction, director, year, genre and score, etc., and the video description information of a variety show may comprise the broadcast time, etc.

The play address is a storage address of a video in a network, for example, it may be a Uniform/Universal Resource Locator (URL) address, etc. Therein, there may exist multiple play addresses for a video represented by the same video description information, for example, link addresses corresponding to each video website such as Youku, Tudou, Sohu, Thunder, iQIYI, etc. respectively, and the link addresses can be stored in table 1 respectively.

Of course, the video information may further comprise such data as a play parameter and a rank, etc., see the discussion later.

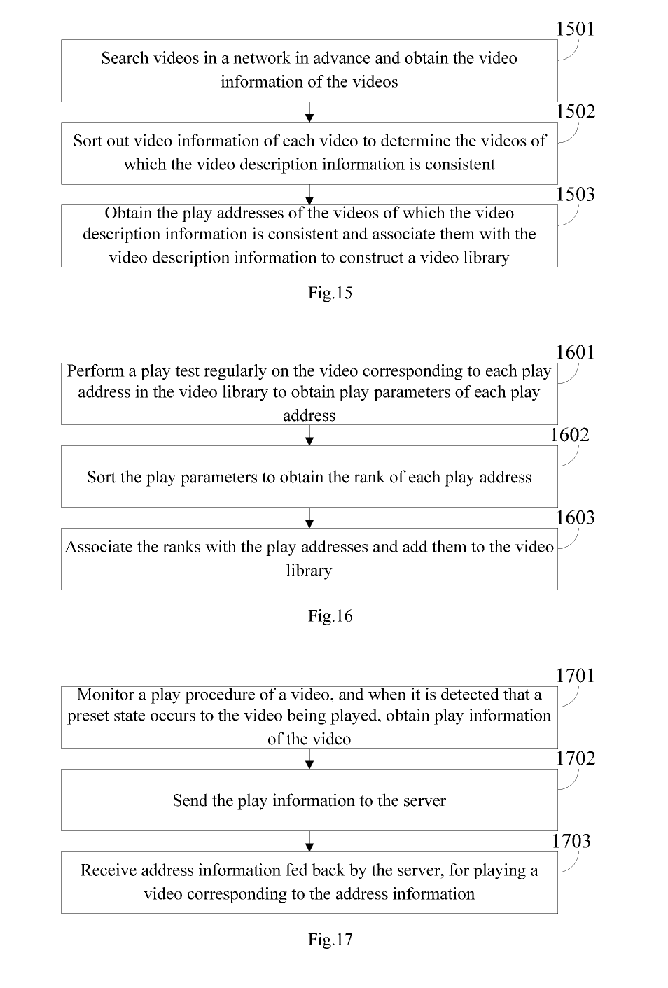

FIG. 15 shows a flow chart of a first method for presetting a video library according to the embodiment one of the invention.

In the embodiment of the invention, the presetting a video library in the server comprises the following steps.

Step 1501, searching videos in a network in advance and obtaining video information of the videos.

Therein, the video information comprises: video description information and play addresses.

All kinds of videos are searched in a network in advance, resources of the each video are obtained and video information thereof are extracted, for example, video description information and play addresses, etc.

Step 1502, sorting out video information of each video to determine the videos of which the video description information is consistent.

Video information of videos is sorted out, such that it can be obtained that the video information of a part of the video description information is consistent. By consistent, it refers that part of or all of the video description information of the videos is identical, for example, the names are identical, and for another example, the introductions are identical, and the like.

In the embodiment of the invention, when in the video description information of any two videos, when identical information reaches a preset scope, the video description information of the two videos can be considered consistent, for example, there are 10 kinds of video description information of the two videos, and if 8 out of the 10 kinds are identical, then the video description information of the two videos can be considered consistent.

Thus, the videos of which the video description information is consistent can be determined by the above approach.

Step 1503, obtaining the play addresses of the videos of which the video description information is consistent and associating it with the video description information to construct a video library.

Then the play addresses of the videos of which the video description information is consistent are associated with the corresponding video description information to construct a video library. That is, in the video library, one piece of video description information may correspond to multiple play addresses, as shown in table 1.

FIG. 16 shows a flow chart of a second method for presetting a video library according to the embodiment one of the invention.

In the embodiment of the invention, on the basis of the above method for presetting a video library, the method for presetting a video library in a server further comprises:

Step 1601, performing a play test regularly on videos corresponding to each play address in the video library to obtain play parameters of the each play address.

In the embodiment of the invention, a play test may further performed regularly to the play addresses of each video in the video library, wherein by regularly, it means at a fixed time, for example, every 24 hours, or 0:00 o'clock every day, etc. That is, a corresponding video is obtained through the play address and played, thereby testing out the average download speed, play time, etc. of the video, and it may be further tested out that whether there is a phenomenon of being stuck, slow, etc. in the play of the video, thereby forming the play parameters. Then, the play parameters may comprise the average download speed, the play time, the number of times that a phenomenon of being stuck, slow, etc. appears, and the like.

At this point, the play condition of each video can be tested out, for example, if the bandwidth of a server itself providing a video is small, then the average download speed of this video may be low; for another example, if a problem occurs to the interaction between a video and a page, then the phenomenon of being stuck, slow, etc. may often occur to the video. Thereby, the play condition of each video can be determined in a pre-test.

Step 1602, sorting the play parameters, and obtaining the rank of each play address.

Then, the play parameters can be sorted, for example, the average download speeds are sorted, or the numbers of times that the phenomenon of being stuck, slow, etc. appears are sorted, or the like. Of course, various data in the play parameters can be combined to obtain the rank of each video, namely, each play address.

Therein, the rank may be the sorting of each play address from high to low in play quality; the play quality being high can be understood as that at least one of the following conditions take places: the average download speed is high, or the number of times that the phenomenon of being stuck, slow, etc. is little; and then the play quality being low can be understood as that at least one of the following conditions take places: the average download speed is low, or the number of times that the phenomenon of being stuck, slow, etc. is large.

Step 1603, associating the ranks with the play addresses, and adding them to the video library.

Then, the ranks can be associated with corresponding play addresses, thereby corresponding play addresses can be determined by the ranks, and the ranks are added to the video library, as shown in table 1.

Determining a video matching the play information, and obtaining the address information of the matching video:

matching the play information with video description information in the video library to determine the matched video description information; and obtaining each play address associated with the matched video description information, and forming each play address into address information.

In the embodiment of the invention, the play information may comprise part of the video description information such as the name, introduction, etc. of the video, and therefore the play information can be matched with video description information in the video library, for example, the name in the play information is matched with a name in the video description information, thereby obtaining the matched video description information.

Then, each play address associated with the matched video description information are obtained, and each play address is formed into address information, and at this point, one of the play addresses can be obtained to form the address information, or also multiple play addresses can be obtained to form the address information, which will not be defined by the embodiment of the invention.

Obtaining each play address associated with the matched video description information, and forming each play address into address information comprises:

obtaining each play address associated with the matched video description information, and obtaining the rank associated with each play address; and obtaining play addresses ranked top predetermined order from the ranks, and forming the play addresses of the top predetermined order into the address information.

Each play address associated with the matched video description information is obtained, and then the rank associated with each play address can be obtained. Then, play addresses ranked top predetermined order are obtained from the ranks, wherein the top predetermined order is a preset value, e.g., 5, 10, etc., and thereby the number of play addresses fed back can be determined by the top predetermined order.

After the play addresses of the top predetermined order are determined, the play addresses of the top predetermined order can be formed into the address information.

In the embodiment of the invention, after forming the play addresses of the top predetermined order into the address information, there is further comprised:

adding the ranks associated with the play addresses of the top predetermined order to the address information.

In the embodiment of the invention, the ranks associated with the play addresses of the top predetermined order may further be added to the address information, and thereby the rank of each play address can be determined by the address information, thus facilitating the selection by a user.

In addition, the play information further comprises the stop time of a video, that is, the time that the video has been played when sending the play information, for example, a video of 90 minutes is stopped at 45 minute. Therefore, the address information fed back by the server may also comprise the stop time, and after the play address is re-selected, the point of time for play can be configured to be the stop time, and in turn the play can be started from the stop time.

In summary, in the embodiment of the invention, a video library can be formed by obtaining video description information, play addresses, etc. of videos in a network, and thereby when a preset condition occurs to the play of a video in the browser, the video can be matched quickly in the video library, and time is saved.

Secondly, a play test can further be performed regularly on videos corresponding to each play address in the video library, thereby play parameters of each play addresses can be obtained, and the rank of each play addresses is determined and added to the video library, so, the play condition of each play address can be determined in advance, and thereby play addresses of which the play conditions are better are fed back to the user.

### Embodiment Two

The processing of the browser in the method for playing a video is mainly discussed in this embodiment, which particularly comprises:

FIG. 17 shows a flow chart of a method for playing a video according to an embodiment two of the invention.

An embodiment of the invention further provides a method for playing a video comprising the following steps.

Step 1701, monitoring the play procedure of a video, and when it is detected that a preset state occurs to the video being played, obtaining the play information of the video.

In the embodiment of the invention, the browser may monitor the play procedure of a video in real time during playing the video, and thereby obtain the play information of the video when it is detected that a preset state occurs to the video being played.

Therein, the preset state comprises any of the following: 1. failing to obtain data of the video; 2. the time that the video stops being played exceeds a first preset time; and 3. the difference of the real play time of the video minus a theoretical play time exceeds a second preset time.

When selecting a video to be played in a browser, data of the video will be downloaded from a server of the video for playing the video, and at this point, if the data of the video can not be downloaded, it can be considered as failing to obtain the video. Therein, failing to obtain the video may take place before the play, and at this point, the video can not be played at all; or it may also take place in the play, and at this point, the video can not continue to be played.

The first preset time is a maximum time that the video stops being played, for example, 1 minute, 3 minutes, etc. If the time that the video stops being played exceeds the first preset time, namely, the time that the video stops being played exceeds the maximum time, then it can be considered that a preset condition occurs to the video play, and another play address can be recommended to the user for watching the video again.

The real play time is a period of time from starting to play the video to the present, for example, if it starts at 9:00, and the present is 9:40, then the real play time is 40 minutes. The theoretical play time is the time corresponding to the data of the video currently played. For example, the video is of 100 M, the total time is 100 minutes, and if 30 M is played at present, then the theoretical play time is 30 minutes.

The second preset time is a time measuring the video play progress. For example, a situation that the video stops for a long time may not appear, but it may stop for moment and be played for a moment, the play effect is very poor and affects the watch of the user. Therefore, the second preset time can be employed to measure, that is, when the difference of the real play time of the video minus the theoretical play time exceeds the second preset time, for example, the real play time of the video from starting to play the video to the present is 40 minutes, but the theoretical play time is 30 minutes, and the second preset time is 5 minutes, then 40−30=10>5, which exceeds the second preset time.

In the embodiment of the invention, an independent process can be employed in the browser to play a video, and then monitoring the play procedure of a video comprises:

monitoring the play procedure of the video in the independent process.

In the embodiment of the invention, an independent process can further be employed to play a video, and thereby the play procedure of the video in the independent process can be monitored.

Therein, a flash is taken as an example to describe briefly the procedures of invocation and communication of the independent process as follows:

In a case where there is a flash in the web page, when the browser creates an ActiveX plug-in (a flash plug-in in this example), it will query a registry to examine whether the corresponding plug-in has been installed in the system according to the CLSID or ProgID (CLSID is obtained by CLSIDFromProgID) of the plug-in, and if installed, the creation procedure will continue. The browser obtains the IUnknown pointer of the corresponding plug-in by invoking CoGetClassObject, and then an interoperation is done by a standard interface. The execution procedure of CoGetClassObject is as follows. The registry is queried for an ActiveX path through the CLSID, and after the ActiveX path is obtained, LoadLibrary is invoked to load the ActiveX plug-in, its derivative function DllGetClassObject is invoked to obtain a class factory pointer (IClassFactory), and then the CreateInstance method of IClassFactory is invoked to obtain the IUnknown pointer corresponding to the ActiveX plug-in.

The particular procedure is as follows:

When the ActiveX plug-in is loaded in a web page, CoGetClassObject is Hooked to create an ActiveX control object. The ActiveX control object comprises a series of interfaces, for example, many standard interfaces that the IUnknown pointer will invoke, such as IOleObject, IViewObject, etc. Then, when CreateInstance of IClassFactory is invoked, the created ActiveX control object is returned to the IUnknown pointer of the ActiveX plug-in.

When the page process activates the ActiveX plug-in, relevant information such as attribute, URL and size, etc. of the control is extracted, and then an independent process is created. In particular, a document is created, an object is inserted therein, the independent process invokes CoGetClassObject, Hooks the CoGetClassObject and then creates another ActiveX control object, and the ActiveX control object comprises a series of interfaces, for example, many standard interfaces that the IUnknown pointer will invoke, such as IOleObject, IViewObject, etc. Then, when CreateInstance of IClassFactory is invoked, the created another ActiveX control object is returned to the IUnknown pointer of the ActiveX plug-in of the independent process.

In the created two ActiveX control objects, a window associated with each control object is respectively created for communication. In particular, the two control objects may interact with each other with respect to the size, focus, refresh, script and other information.

In the embodiment of the invention, all the requests from the above two processes can be intercepted, and the information interaction between the two processes is realized by the pre-created two ActiveX control objects. Therefore, the particular procedure of the flash plug-in is performed in the independent process, and therefore will not affect the original web page process.

By using an independent process to play a video, the video can be better controlled, and thereby the play condition of the video is determined.

Step 1702, sending the play information to the server.

The play information may comprise the name, play time, etc., and then the play information can be sent to the server, such that the server matches out a corresponding video(s) according to the play information.

Step 1703, receiving the address information fed back by the server for playing a video corresponding to the address information.

The address information fed back by the server is received, a corresponding play address is chosen from the address information, and thereby a video corresponding to the play address is played.

In particular, it comprises:

receiving the address information fed back by the server, and displaying play addresses in the address information; and receiving a play instruction, and playing a corresponding video according to the play instruction.

The address information fed back by the server is received, and play addresses in the address information are displayed, and the user can select a play address therefrom, that is, send a play instruction, wherein the play instruction contains the selected play address, and thereby a video corresponding to the play address can be played.

Therein, after an independent process is employed to play the video, the video can be better controlled, and thereby the play condition of the video is determined.

In this embodiment, the stop time of the video when the video information is sent may further be recorded, and after a play instruction is received for playing a video, there may be further comprised taking the stop time as the time to start playing, such that a newly played video can start to be played from the time it stopped previously, which is convenient for the user to watch.

### Embodiment Three

In the above the processing of the browser and the server in the method for playing a video are discussed. In the following, the method for playing a video will be described from an overall perspective, which particularly comprises:

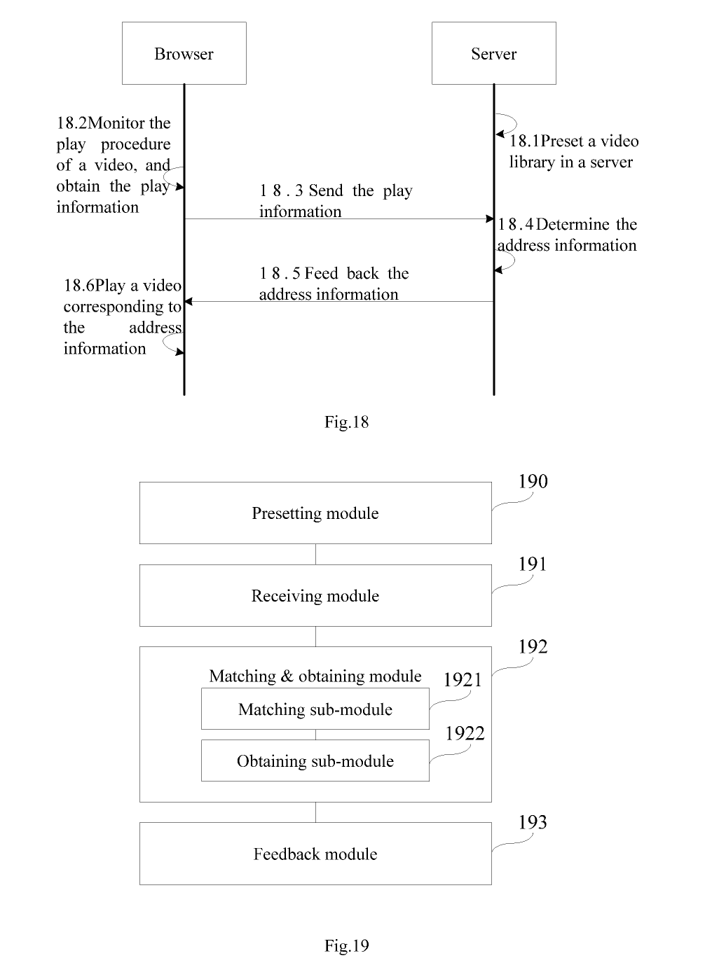

FIG. 18 shows a schematic diagram of a method for playing a video according to an embodiment three of the invention.

18.1 Presetting a video library in a server

In particular, there are comprised the following steps:

18.11 Searching videos in a network in advance and obtaining video information of the videos, wherein the video information comprises: video description information and play addresses;

18.12 Sorting out video information of each video to determine the videos of which the video description information is consistent;

18.13 Obtaining the play addresses of the videos of which the video description information is consistent and associating them with the video description information to construct a video library.

There are further comprised:

18.14 Performing a play test regularly on the video corresponding to each play address in the video library to obtain play parameters of each play address;

18.15 Sorting the play parameters to obtain the rank of each play address;

18.16 Associating the ranks with the play addresses and adding them to the video library.

18.2 The browser monitoring the play procedure of a video, and when it is detected that a preset state occurs to the video being played, obtaining the play information of the video.

Therein, the preset state comprises any of the following: failing to obtain data of the video, the time that the video stops being played exceeds a first preset time, and the difference of the real play time of the video minus a theoretical play time exceeds a second preset time.

Optionally, an independent process is employed in the browser to play a video, and then the play procedure of the video in the independent process is monitored.

18.3 The browser sending the play information to the server.

18.4 The browser determining a video matching the play information, and obtaining the address information of the matching video.

In particular, there are comprised the following steps:

18.41 Matching the play information with video description information in the video library to determine the matched video description information,

18.42 Obtaining individual play addresses associated with the matched video description information, and forming each play addresses into address information,

18.421 Obtaining each play address associated with the matched video description information, and obtaining the rank associated with each play address;

18.422 Obtaining play addresses ranked top predetermined order from the ranks, and forming the play addresses of the top predetermined order into the address information;

18.423 Adding the ranks associated with the play addresses of the top predetermined order to the address information.

18.5 The server feeding the address information back to the browser.

18.6 Receiving the address information fed back by the server for playing a video corresponding to the address information.

18.61 Receiving the address information fed back by the server, and displaying play addresses in the address information;

18.62 Receiving a play instruction, and playing a corresponding video according to the play instruction.

In summary, in the embodiment of the invention, corresponding play information is obtained when a preset state appears in video play, then the address information of a video matching the play information is determined, and the address information id fed back, such that the browser can play the video according to the address information, the video can be watched normally, and the problems of being stuck, slow and failing to be played, etc. are avoided as much as possible.

### Embodiment Four

FIG. 19 shows a structural diagram of a server according to an embodiment four of the invention.

The embodiment of the invention further provides a server comprising:

a receiving module 191 configured to receive play information obtained by a browser, wherein the play information is obtained in a video in which a preset state appears when played;

a matching & obtaining module 192 configured to determine a video matching the play information and obtain the address information of the matching video; and

a feedback module 193 configured to feed the address information back to the browser.

In the embodiment of the invention, the server further comprises:

a presetting module 190 configured to preset a video library in the server, the video library is configured to store video information of videos in the network.

In the embodiment of the invention, the presetting module 190 is particularly configured to search videos in a network in advance and obtain the video information of the videos, wherein the video information comprises: video description information and play addresses; sort out video information of each video to determine the videos of which the video description information is consistent; and obtain the play addresses of the videos of which the video description information is consistent and associate them with the video description information to construct a video library.

In the embodiment of the invention, the presetting module 190 is further configured to perform a play test regularly on the video corresponding to each play address in the video library to obtain play parameters of each play address; sort the play parameters to obtain the rank of each play address; and associate the ranks with the play addresses and add them to the video library.

In the embodiment of the invention, the matching & obtaining module 192 comprises:

a matching sub-module 1921 configured to match the play information with video description information in the video library to determine the matched video description information; and

an obtaining sub-module 1922 configured to obtain each play address associated with the matched video description information, and form each play address into address information.

In the embodiment of the invention, the obtaining sub-module 1922 is particularly configured to obtain each play address associated with the matched video description information, and obtain the rank associated with each play address; and obtain play addresses ranked top predetermined order from the ranks, and form the play addresses of the top predetermined order into the address information.

In the embodiment of the invention, the obtaining sub-module 1922 is particularly configured to add the ranks associated with the play addresses of the top predetermined order to the address information.

In the embodiment of the invention, the preset state comprises any of the following: failing to obtain data of the video, the time that the video stops being played exceeds a first preset time, and the difference of the real play time of the video minus a theoretical play time exceeds a second preset time.

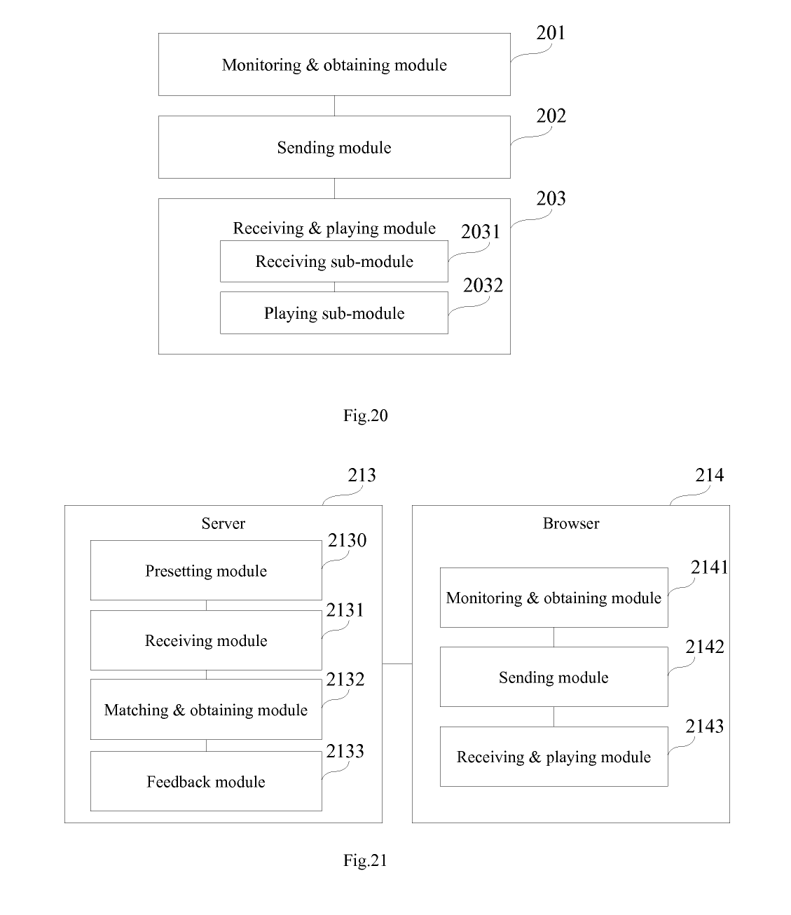

FIG. 20 shows a structural diagram of a browser according to the embodiment four of the invention;

The embodiment of the invention further provides a browser comprising:

a monitoring & obtaining module 201 configured to monitor the play procedure of a video, and when it is detected that a preset state occurs to the video being played, obtain the play information of the video;

a sending module 202 configured to send the play information to the server; and

a receiving & playing module 203 configured to receive the address information fed back by the server for playing a video corresponding to the address information.

In the embodiment of the invention, the receiving & playing module 203 comprises:

a receiving sub-module 2031 configured to receive the address information fed back by the server, and display play addresses in the address information; and

a playing sub-module 2032 configured to receive a play instruction, and play a corresponding video according to the play instruction.

In the embodiment of the invention, an independent process is employed in the browser to play a video; and

the monitoring & obtaining module 2031 is particularly configured to monitor the play procedure of the video in the independent process.

In the embodiment of the invention, the preset state comprises any of the following: failing to obtain data of the video, the time that the video stops being played exceeds a first preset time, and the difference of the real play time of the video minus a theoretical play time exceeds a second preset time.

### Embodiment Five

FIG. 21 shows a structural diagram of a system for playing a video according to an embodiment five of the invention.

The embodiment of the invention further provides a system for playing a video comprising a server 213 and a browser 214.

The server 213 comprises:

a receiving module 2131 configured to receive play information obtained by a browser, wherein the play information is obtained in a video in which a preset state appears when played;

a matching & obtaining module 2132 configured to determine a video matching the play information and obtain the address information of the matching video; and

a feedback module 2133 configured to feed the address information back to the browser.

In the embodiment of the invention, the server further comprises:

a presetting module 2130 configured to preset a video library in the server, the video library is configured to store video information of videos in the network.

In the embodiment of the invention, the presetting module 2130 is particularly configured to search videos in a network in advance and obtain the video information of the videos, wherein the video information comprises: video description information and play addresses; sort out video information of each video to determine the videos of which the video description information is consistent; and obtain the play addresses of the videos of which the video description information is consistent and associate them with the video description information to construct a video library.

In the embodiment of the invention, the presetting module 2130 is further configured to perform a play test regularly on the video corresponding to each play address in the video library to obtain play parameters of each play address; sort the play parameters to obtain the rank of each play address; and associate the ranks with the play addresses and add them to the video library.

In the embodiment of the invention, the matching & obtaining module 2132 comprises:

a matching sub-module configured to match the play information with video description information in the video library to determine the matched video description information; and

an obtaining sub-module configured to obtain each play address associated with the matched video description information, and form each play address into address information.

In the embodiment of the invention, the obtaining sub-module is particularly configured to obtain each play address associated with the matched video description information, and obtain the rank associated with each play address; and obtain play addresses ranked top predetermined order from the ranks, and form the play addresses of the top predetermined order into the address information.

In the embodiment of the invention, the obtaining sub-module is particularly configured to add the ranks associated with the play addresses of the top predetermined order to the address information.

In the embodiment of the invention, the preset state comprises any of the following: failing to obtain data of the video, the time that the video stops being played exceeds a first preset time, and the difference of the real play time of the video minus a theoretical play time exceeds a second preset time.

The browser 214 comprises:

a monitoring & obtaining module 2141 configured to monitor the play procedure of a video, and when it is detected that a preset state occurs to the video being played, obtain the play information of the video;

a sending module 2142 configured to send the play information to the server; and

a receiving & playing module 2143 configured to receive the address information fed back by the server for playing a video corresponding to the address information.

In the embodiment of the invention, the receiving & playing module 2143 comprises:

a receiving sub-module configured to receive the address information fed back by the server, and display play addresses in the address information; and

a playing sub-module configured to receive a play instruction, and play a corresponding video according to the play instruction.

In the embodiment of the invention, an independent process is employed in the browser to play a video; and

the monitoring & obtaining module is particularly configured to monitor the play procedure of the video in the independent process.

In the embodiment of the invention, the preset state comprises any of the following: failing to obtain data of the video, the time that the video stops being played exceeds a first preset time, and the difference of the real play time of the video minus a theoretical play time exceeds a second preset time.

In summary, in embodiments of the invention, corresponding play information can be obtained when a preset state appears in video play, then the address information of videos matching the play information is determined, and the address information is fed back, such that the browser can play a video according to the address information, a user can watch the video normally, and the problems of being stuck, slow and failing to be played, etc. are avoided as much as possible.

In embodiments of the invention, a video library can be formed by obtaining video description information, play addresses, etc. of videos in a network, and thereby when a preset condition occurs to the play of a video in the browser, the video can be matched quickly in the video library, and time is saved.

Secondly, a play test may further be performed regularly on the video corresponding to each play address in the video library, thereby play parameters of each play address can be obtained, and the rank of each play address is determined and added to the video library, so, the play condition of each play address can be determined in advance, and thereby play addresses of which the play conditions are better are fed back to the user.

Embodiments of each component of the invention may be implemented in hardware, or in a software module running on one or more processors, or in a combination thereof. It will be appreciated by those skilled in the art that, in practice, some or all of the functions of some or all of the components in an apparatus according to individual embodiments of the invention may be realized using a microprocessor or a digital signal processor (DSP). The invention may also be implemented as an apparatus or a device program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

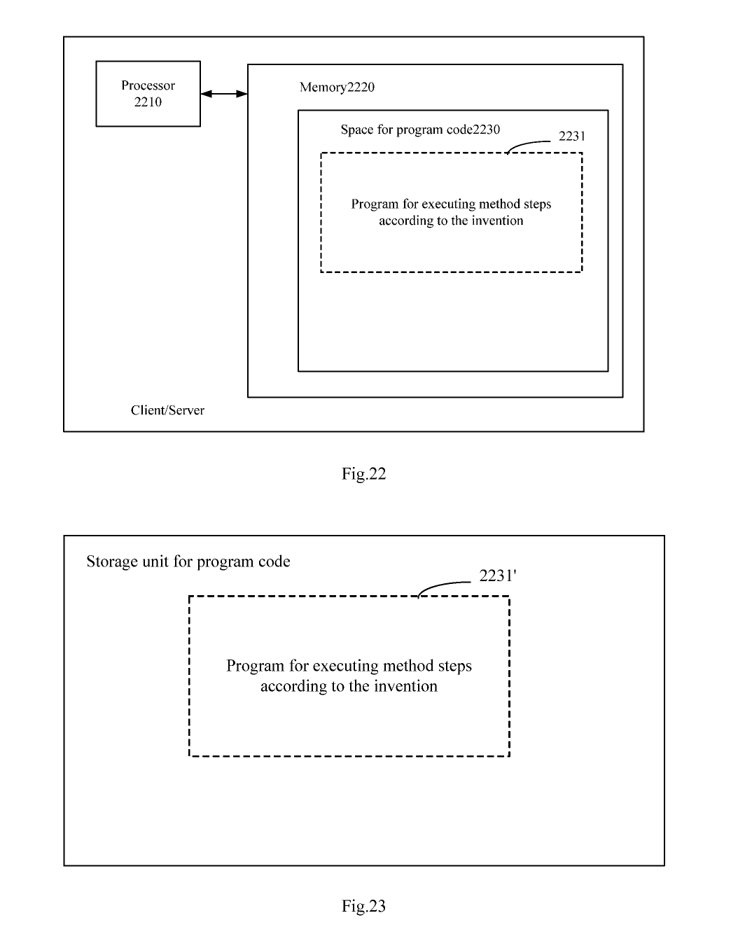

For example, FIG. 22 shows a client or server which may carry out a method according to the invention. The client or server traditionally comprises a processor 2210 and a computer program product or a computer readable medium in the form of a memory 2220. The memory 2220 may be an electronic memory such as a flash memory, an EEPROM (electrically erasable programmable read-only memory), an EPROM, a hard disk or a ROM. The memory 2220 has a memory space 2230 for a program code 2231 for carrying out any method steps in the methods as described above. For example, the memory space 2230 for a program code may comprise individual program codes 2231 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 23. The storage unit may have a memory segment, a memory space, etc. arranged similarly to the memory 2220 in the client or server of FIG. 22. The program code may for example be compressed in an appropriate form. In general, the storage unit comprises a computer readable code 2231′, i.e., a code which may be read by e.g., a processor such as 2210, and when run by a server, the codes cause the server to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several devices, several of the devices may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

Embodiments according to the invention disclose: A1: A method for creating a browser active object comprising: before the browser creates an active object, preventing the creation of the active object; and continuing to create the active object according to a request for executing the function accomplished by the active object initiated by a user, and afterwards, executing the function accomplished by the active object. A2: The method as claimed in A1, wherein the step of before the browser creates an active object, preventing the creation of the active object, comprises: preventing the creation of the active object in a page process of the browser. A3: The method as claimed in A2, wherein the step of continuing to create the active object according to a request for executing the function accomplished by the active object initiated by a user, and afterwards, executing the function accomplished by the active object, comprises: intercepting the operation of the page process of the browser creating an active object, creating a proxy object in the page process of the browser to replace the active object to be created actually, the proxy object being running in the page process; creating the active object in an independent process independent from the page process of the browser; and executing the function accomplished by the active object by invoking the active object by the proxy object communicating with the independent process, and/or by the proxy object communicating with the independent process and being invoked by the active object. A4: The method as claimed in any one of A1-A3, wherein the step of preventing the creation of the active object comprises: obtaining a class identification of the active object, and stopping executing the operation of querying the registry according to the class identification of the active object. A5: The method as claimed in A4, wherein the step of continuing to create the active object comprises: continuing to execute the operation of querying the registry according to the class identification of the active object.

Embodiments according to the invention disclose: B6: A method for creating a browser active object comprising: after the browser creates an active object, preventing the execution of the function accomplished by the active object by intercepting a timing message in a thread message loop or by modifying an attribute of the active object; according to a request for executing the function accomplished by the active object initiated by a user, continuing to execute the function accomplished by the active object by cancelling the interception of the timing message in the thread message loop or by re-modifying the attribute of the active object. B7: The method as claimed in B6, wherein before the browser creates an active object, there is further comprised: intercepting the operation of the page process of the browser loading an active object, and creating a proxy object in the page process of the browser to replace the active object to be created actually, wherein the proxy object is run in the page process; the procedure of the browser creating an active object is in particular as follows: creating the active object in an independent process independent from the page process of the browser; the step of continuing to execute the function accomplished by the active object is in particular as follows: executing the function accomplished by the active object by invoking the active object by the proxy object communicating with the independent process, and/or by the proxy object communicating with the independent process and being invoked by the active object. B8: The method as claimed in B6 or B7, wherein the timing message is the 0x401 message. B9: The method as claimed in B6 or B7, wherein the step of modifying an attribute of the active object comprises: obtaining an interface pointer of the active object; and finding a function recording attributes of the active object according to the interface pointer, and modifying an attribute of the active object by invoking the function. B10: The method as claimed in B6, wherein before the step of continuing to execute the function accomplished by the active object, there is comprised: intercepting the drawing function of the active object, invoking a customized drawing function to draw a customized interface, and displaying the customized interface at a specified position of the browser. B11: The method as claimed in B7, wherein before the step of continuing to execute the function accomplished by the active object, there is comprised: intercepting the drawing function of the active object in the independent process, invoking a customized drawing function to draw a customized interface, invoking the active object by the proxy object communicating with the independent process, and displaying the customized interface at a specified position of the browser; or intercepting in the page process the action of invoking the active object by the proxy object communicating with the independent process, invoking a customized drawing function to draw a customized interface, and displaying the customized interface at a specified position of the browser.

Embodiments according to the invention disclose: C12: A device for creating a browser active object comprising a prevention module configured to prevent the creation of an active object in the page process before the browser creates the active object; a first creation module configured to continue to create the active object according to a request for executing the function accomplished by the active object initiated by a user; and an execution module configured to execute the function accomplished by the active object after the first creation module creates the active object. C13: The device as claimed in C12, wherein the device comprises a page process module, and the prevention module, the first creation module and the execution module are all sub-modules of the page process module; and the prevention module is particularly configured to prevent the creation of an active object in the page process. C14: The device as claimed in C12, wherein the device comprises a page process module and an independent process module; the prevention module is a sub-module of the page process module, and the first creation module and the execution module are sub-modules of the independent process module; the page process module further comprises: a second creation module configured to, according to a request for executing the function accomplished by an active object initiated by the user, intercept the operation of the page process of the browser loading an active object, and create a proxy object in the page process of the browser to replace the active object to be created actually, wherein the proxy object is run in the page process; the first creation module is particularly configured to create the active object in an independent process independent of the page process of the browser; and the device further comprises communication windows created in the page process module and the independent process module respectively, and the execution module is particularly configured to execute the function accomplished by the active object by invoking the active object by the proxy object communicating with the independent process via the communication window, and/or by the proxy object communicating with the independent process via the communication window and being invoked by the active object. C15: The device as claimed in any one of C12-C14, wherein the prevention module is particularly configured to obtain a class identification of the active object, and stop executing the operation of querying the registry according to the class identification of the active object. C16: The device as claimed in C13, wherein the first creation module is particularly configured to continue to execute the operation of querying the registry according to the class identification of the active object.

Embodiments according to the invention disclose: D17: A browser comprising a device for creating a browser active object as claimed in any one of C12-C16.

Embodiments according to the invention disclose: E18: A device for creating a browser active object comprising: a prevention module configured to, after the browser creates an active object, prevent the execution of the function accomplished by the active object by intercepting a timing message in a thread message loop or by modifying an attribute of the active object; an execution module configured to, according to a request for executing the function accomplished by the active object initiated by a user, continue to execute the function accomplished by the active object by cancelling the interception of the timing message in the thread message loop or by re-modifying the attribute of the active object. 19: The device as claimed in 18, wherein the device comprises a page process module; and the prevention module and the execution module are sub-modules of the page process module. 20: The device as claimed in 18, wherein the device comprises a page process module and an independent process module; the prevention module and the execution module are sub-modules of the independent process module; the page process module further comprises: a first creation module configured to intercept the operation of the page process of the browser loading an active object, create a proxy object in the page process of the browser to replace the active object to be created actually, wherein the proxy object is run in the page process; the independent process module further comprises: a second creation module configured to create an active object in an independent process independent from the page process; the device further comprises communication windows created in the page process module and the independent process module respectively, and the execution module is further configured to continue to execute the function accomplished by the active object by invoking the active object by the proxy object communicating with the independent process via the communication window, and/or by the proxy object communicating with the independent process via the communication window and being invoked by the active object. E21: The device as claimed in any one of E18-E20, wherein the timing message is the 0x401 message. E22: The device as claimed in any one of E18-E20, wherein the prevention module is particularly configured to obtain an interface pointer of the active object; and find a function recording attributes of the active object according to the interface pointer, modify an attribute of the active object by invoking the function, and prevent the execution of the function accomplished by the active object. E23: The device as claimed in E19, further comprising: a drawing module configured to intercept the drawing function of the active object, invoke a customized drawing function to draw a customized interface, and display the customized interface at a specified position of the browser. E24: The device as claimed in E20, wherein the independent process module further comprises: a drawing module configured to intercept the drawing function of the active object in the independent process, and invoke a customized drawing function to draw a customized interface; the page process module further comprises: a display module configured to invoke the active object by the proxy object communicating with the independent process, and display the customized interface at a specified position of the browser. E25: The device as claimed in E20, wherein the page process module further comprises: a drawing module configured to intercept in the page process the action of invoking the active object by the proxy object communicating with the independent process, invoke a customized drawing function to draw a customized interface, and display the customized interface at a specified position of the browser.

Embodiments according to the invention disclose: F26: A browser comprising a device for creating a browser active object as claimed in any one of E18-E25.

Embodiments according to the invention disclose: G1: A method for playing a video comprising: receiving play information obtained by a browser, wherein the play information is obtained in a video in which a preset state appears when played; determining a video matching the play information and obtaining the address information of the matching video; and feeding the address information back to the browser. G2: The method as claimed in G1, further comprising: presetting a video library in the server, the video library is configured to store video information of videos in the network. G3: The method as claimed in G2, wherein the presetting a video library in the server comprises: searching videos in a network in advance and obtaining the video information of the videos, wherein the video information comprises: video description information and play addresses; sorting out video information of each video to determine the videos of which the video description information is consistent; and obtaining the play addresses of the videos of which the video description information is consistent and associating them with the video description information to construct a video library. G4: The method as claimed in G3, further comprising: performing a play test regularly on the video corresponding to each play address in the video library to obtain play parameters of each play address; sorting the play parameters to obtain the rank of each play address; and associating the ranks with the play addresses and adding them to the video library. G5: The method as claimed in any one of G3 or G4, wherein the determining a video matching the play information and obtaining the address information of the matching video comprises: matching the play information with video description information in the video library to determine the matched video description information; and obtaining each play address associated with the matched video description information, and forming each play address into address information. G6: The method as claimed in G5, wherein obtaining each play address associated with the matched video description information and forming each play address into address information comprises: obtaining each play address associated with the matched video description information, and obtaining the rank associated with each play address; and obtaining play addresses ranked top predetermined order from the ranks, and forming the play addresses of the top predetermined order into the address information. G7: The method as claimed in G6, further comprising: adding the ranks associated with the play addresses of the top predetermined order to the address information. G8: The method as claimed in G1, wherein the preset state comprises any of the following: failing to obtain data of the video, the time that the video stops being played exceeds a first preset time, and the difference of the real play time of the video minus a theoretical play time exceeds a second preset time.

Embodiments according to the invention disclose: H9: A method for playing a video comprising: monitoring a play procedure of a video, and when it is detected that a preset state occurs to the video being played, obtaining play information of the video; sending the play information to a server; and receiving the address information fed back by the server for playing a video corresponding to the address information. H10: The method as claimed in H9, wherein receiving the address information fed back by the server for playing a video corresponding to the address information comprises: receiving the address information fed back by the server, and displaying play addresses in the address information; and receiving a play instruction, and playing a corresponding video according to the play instruction. H11: The method as claimed in H9, wherein an independent process is employed in the browser to play a video, and monitoring the play procedure of a video comprises: monitoring the play procedure of the video in the independent process. H12: The method as claimed in H9, wherein the preset state comprises any of the following: failing to obtain data of the video, the time that the video stops being played exceeds a first preset time, and the difference of the real play time of the video minus a theoretical play time exceeds a second preset time.

Embodiments according to the invention disclose: I13: A server comprising: a receiving module configured to receive play information obtained by a browser, wherein the play information is obtained in a video in which a preset state appears when played; a matching & obtaining module configured to determine a video matching the play information and obtain address information of the matching video; and a feedback module configured to feed the address information back to the browser. I14: The server as claimed in I13, further comprising: a presetting module configured to preset a video library in the server, the video library is configured to store video information of videos in the network. I15: The server as claimed in I14, wherein the presetting module is particularly configured to search videos in a network in advance and obtain the video information of the videos, wherein the video information comprises: video description information and play addresses; sort out video information of each video to determine the videos of which the video description information is consistent; and obtain the play addresses of the videos of which the video description information is consistent and associate them with the video description information to construct a video library. I16: The server as claimed in I15, wherein the presetting module is further configured to perform a play test regularly on the video corresponding to each play address in the video library to obtain play parameters of each play address; sort the play parameters to obtain the rank of each play address; and associate the ranks with the play addresses and add them to the video library. I17: The server as claimed in any one of I15 or I16, wherein the matching & obtaining module comprises: a matching sub-module configured to match the play information with video description information in the video library to determine the matched video description information; and an obtaining sub-module configured to obtain each play address associated with the matched video description information, and form each play address into address information. I18: The server as claimed in I17, wherein the obtaining sub-module is particularly configured to obtain each play address associated with the matched video description information, and obtain the rank associated with each play address; and obtain play addresses ranked top predetermined order from the ranks, and form the play addresses of the top predetermined order into the address information. I19: The server as claimed in I18, wherein the obtaining sub-module is particularly configured to add the ranks associated with the play addresses of the top predetermined order to the address information. I20: The server as claimed in I13, wherein the preset state comprises any of the following: failing to obtain data of the video, the time that the video stops being played exceeds a first preset time, and the difference of the real play time of the video minus a theoretical play time exceeds a second preset time.

Embodiments according to the invention disclose: J21: A browser comprising: a monitoring & obtaining module configured to monitor a play procedure of a video, and when it is detected that a preset state occurs to the video being played, obtain play information of the video; a sending module configured to send the play information to the server; and a receiving & playing module configured to receive address information fed back by the server for playing a video corresponding to the address information. J22: The browser as claimed in J21, wherein the receiving & playing module comprises: a receiving sub-module configured to receive the address information fed back by the server, and display play addresses in the address information; and a playing sub-module configured to receive a play instruction, and play a corresponding video according to the play instruction. J23: The browser as claimed in J21, wherein an independent process is employed in the browser to play a video; and the monitoring & obtaining module is particularly configured to monitor the play procedure of the video in the independent process. J24: The browser as claimed in J21, wherein the preset state comprises any of the following: failing to obtain data of the video, the time that the video stops being played exceeds a first preset time, and the difference of the real play time of the video minus a theoretical play time exceeds a second preset time.

Embodiments according to the invention disclose: K25: A system for playing a video comprising a server and a browser, wherein the server comprises a receiving module configured to receive play information obtained by a browser, wherein the play information is obtained in a video in which a preset state appears when played; a matching & obtaining module configured to determine a video matching the play information and obtain the address information of the matching video; and a feedback module configured to feed the address information back to the browser; the browser comprises: a monitoring & obtaining module configured to monitor a play procedure of a video, and when it is detected that a preset state occurs to the video being played, obtain the play information of the video; a sending module configured to send the play information to the server; and a receiving & playing module configured to receive the address information fed back by the server for playing a video corresponding to the address information.

1. A method for playing a plug-in in a browser comprising:
creating an independent process different from a page process when loading and activating a first plug-in in the page process of the browser, and loading and activating a second plug-in in the independent process, wherein the second plug-in copies information of the first plug-in;
calculating information of the second plug-in in the independent process, and obtaining the calculation result; and
drawing and playing the second plug-in in a play window according to the calculation result.

2. The method as claimed in claim 1, wherein the second plug-in copies information of the first plug-in comprises:
generating a first control object for the first plug-in in the page process;
generating a second control object for the second plug-in in the independent process;
utilizing the second control object and the first control object to communicate with each other to obtain the information of the first plug-in; and
utilizing the second control object to send the obtained information of the first plug-in to the second plug-in.

3. The method as claimed in claim 2, wherein
an interoperation is done by a pointer between the first plug-in and the first control object, wherein the pointer can invoke a plurality of standard interfaces; and
an interoperation is done by a pointer of the same type between the second plug-in and the second control object.

4. The method as claimed in claim 2, wherein utilizing the second control object and the first control object to communicate with each other comprises:
creating a first window associated with the first control object in the page process;
creating a second window associated with the second control object in the independent process; and
performing an interactive communication utilizing the first window and second window.

5. The method as claimed in claim 2, wherein the information of the interactive communication comprises at least one of the following:
size of the plug-in, focus of a thread in the page process, refresh operation of a thread of the page process, and execution of a script.

6. The method as claimed in claim 1, wherein drawing and playing the second plug-in in a play window according to the calculation result comprises:
utilizing the independent process to newly create a play window when there is not a play window of the first plug-in in the page process;
regularly obtaining the calculation result according to a timer of the independent process; and
drawing and playing the second plug-in in the newly created play window according to the calculation result.

7. The method as claimed in claim 1, wherein drawing and playing the second plug-in in a play window according to the calculation result comprises:
when there is an original play window of the first plug-in in the page process, utilizing the independent process to newly create a play window and setting the newly created play window to be the parent window of the original play window; and
drawing and playing the second plug-in in the newly created play window according to the calculation result.

8. The method as claimed in claim 6, wherein the newly created play window can move or zoom on the browser.

9. The method as claimed in claim 7, further comprising:
when the page process initiates a request for obtaining a play window, the independent process notifies the page process that there is no play window.

10. The method as claimed in claim 1, wherein the first plug-in and/or the second plug-in is an ActiveX plug-in.

11. A device for playing a plug-in in a browser comprising:
at least one processor to execute a plurality of modules comprising:
a creation module configured to create an independent process different from a page process when loading and activating a first plug-in in the page process of the browser, and load and activate a second plug-in in the independent process, wherein the second plug-in copies information of the first plug-in;
a calculation module configured to calculate information of the second plug-in in the independent process, and obtain the calculation result; and
a play module configured to draw and play the second plug-in in a play window according to the calculation result.

12. The device as claimed in claim 11, wherein the creation module is further configured to:
generate a first control object for the first plug-in in the page process;
generate a second control object for the second plug-in in the independent process;
utilize the second control object and the first control object to communicate with each other to obtain the information of the first plug-in; and
utilize the second control object to send the obtained information of the first plug-in to the second plug-in.

13. The device as claimed in claim 12, wherein
an interoperation is done by a pointer between the first plug-in and the first control object, wherein the pointer can invoke a plurality of standard interfaces; and
an interoperation is done by a pointer of the same type between the second plug-in and the second control object.

14. The device as claimed in claim 12, wherein the creation module is further configured to:
create a first window associated with the first control object in the page process;
create a second window associated with the second control object in the independent process; and
perform an interactive communication utilizing the first window and second window.

15. The device as claimed in claim 12, wherein the information of the interactive communication comprises at least one of the following:
size of the plug-in, focus of a thread in the page process, refresh operation of a thread of the page process, and execution of a script.

16. The device as claimed in claim 11, wherein the play module is further configured to:
utilize the independent process to newly create a play window when there is not a play window of the first plug-in in the page process;
regularly obtain the calculation result according to a timer of the independent process; and
draw and play the second plug-in in the newly created play window according to the calculation result.

17. The device as claimed in claim 11, wherein the play module is further configured to:
when there is an original play window of the first plug-in in the page process, utilize the independent process to newly create a play window and set the newly created play window to be the parent window of the original play window; and
draw and play the second plug-in in the newly created play window according to the calculation result.

18. The device as claimed in claim 16, wherein the newly created play window can move or zoom on the browser.

19. The device as claimed in claim 17, further comprising a notification module configured to, when receiving a request for obtaining a play window initiated by the page process, utilize the independent process to notify the page process that there is no play window.

20. (canceled)

21. (canceled)

22. A non-transitory computer readable medium having instructions stored thereon that, when executed by at least one processor, cause the at least one processor to perform operations for playing a plug-in in a browser, comprising
creating an independent process different from a page process when loading and activating a first plug-in in the page process of the browser, and loading and activating a second plug-in in the independent process, wherein the second plug-in copies information of the first plug-in;
calculating information of the second plug-in in the independent process, and obtaining the calculation result; and
drawing and playing the second plug-in in a play window according to the calculation result.
